(19) United States
(12) Patent Application Publication
(10) Pub. No.: US 2014/0022121 A1
(43) Pub. Date: Jan. 23, 2014

(54) NAVIGATING IN AREAS OF UNCERTAIN POSITIONING DATA

(71) Applicants: Kenneth B. Donovan, Apalachin, NY (US); Scott O. Sorber, Vestal, NY (US)

(72) Inventors: Kenneth B. Donovan, Apalachin, NY (US); Scott O. Sorber, Vestal, NY (US)

(73) Assignee: Lockheed Martin Corporation, Bethesda, MD (US)

(21) Appl. No.: 13/565,581

(22) Filed: Aug. 2, 2012

Related U.S. Application Data
(63) Continuation-in-part of application No. 13/551,441, filed on Jul. 17, 2012.

(51) Int. Cl. G01S 19/12

(52) U.S. Cl. 342/357.49

(57) ABSTRACT

Methods and devices for obtaining a position of a mobile entity. An antenna may be used to receive first signals associated with a first positioning system and second signals associated with a second positioning system. Interference associated with the first and second signals may be monitored. A first location unit coupled to the first receiver may identify a first candidate position by processing first data associated with the first signals. A second location unit coupled to the second receiver may identify a second candidate position by processing second data associated with the second signals. A position may be estimated by applying filter processing to input data comprising the to first candidate position, the second candidate position, and interference data associated with the interference.

### RELATED APPLICATIONS

This application is a continuation-in-part of and claims priority under 35 U.S.C. §120 to U.S. patent application Ser. No. 13/551,441 filed on Jul. 17, 2012 under attorney docket number L0562.70108US00 and titled “Proactive Mitigation of Navigational Uncertainty,” which is incorporated by reference herein in its entirety.

### BACKGROUND

Broadly, navigation may involve identifying an entity's location and/or orientation within a frame of reference. The entity may be a person, a vehicle, an unmanned electrical or mechanical device, etc. A variety of systems for identifying an entity's location are known, such as positioning systems and inertial navigation systems. A positioning system may identify an entity's location by reference to known locations. A positioning system may facilitate detection of an entity's location by transmitting signals from a set of beacons or transmitters having known (though not necessarily fixed) locations. For example, suitable signals may be transmitted from satellites, mobile phone towers, or Wi-Fi access points. The global positioning system (GPS) is an example of a satellite-based positioning system. When four satellite locations and the corresponding distances to a GPS receiver are known, the receiver can compute its position and measure time. One of ordinary skill in the art would understand that the GPS is also an example of a global navigation satellite system (GNSS).

The signals transmitted by a positioning system may permit a suitable receiving device to detect its location via a location-detection method, such as triangulation, trilateration, multilateration, or any other method known to one of ordinary skill in the art or suitable for detecting a location of a receiving device. Triangulation is a method of identifying an entity's location relative to two known locations. Specifically, triangulation involves calculating two angles relative to a baseline through the two known locations: a first angle between the baseline and a line through the first known location and the entity, and a second angle between the baseline and a line through the second known location and the entity. The location of the entity is then calculated by treating the two known locations and the entity's location as the vertices of a triangle and applying simple geometric rules. Multilateration is a method of identifying an entity's location by measuring differences in distances between the entity's location and multiple known locations. Trilateration is similar to triangulation and multilateration, at least in the sense that trilateration, triangulation, and multilateration techniques all use information about the relationships between an entity's location and multiple known locations to pinpoint the entity's location. However, trilateration relies on measurement of distances between the entity's location and the known locations, rather than measurement of angles (as in triangulation) or measurement of differences in distances between the entity's location and the known locations (as in multilateration).

In contrast to a positioning system, an inertial navigation system (INS) estimates an entity's location based on a trusted initial location and data collected from inertial sensors (e.g., accelerometers or gyroscopes). The trusted initial location may be supplied to the INS via a positioning system. Alternatively, a trusted initial location may be supplied by any other system or method known to one of ordinary skill in the art or suitable for identifying a location of a mobile entity. For example, an aircraft may establish a trusted initial location by flying over a landmark having a known location.

After establishing a trusted initial location, the INS integrates the measurements provided by its inertial sensors to estimate the entity's velocity and position as the entity moves. Specifically, the INS collects data from the inertial sensors, uses the inertial sensor data to estimate the entity's velocity (i.e., speed and heading), and uses the estimated velocity to estimate the entity's change in location. The entity's current location is estimated to be the vector sum of the trusted initial location supplied to the INS and the change(s) in location estimated by the INS.

Errors in the INS's estimate of the entity's location may increase over time due to uncompensated errors in the INS sensor measurements. Even if the sensor measurements suffer from only small imprecisions, those imprecisions translate to small errors in the INS estimate of the entity's change in location, which accumulate in the INS estimate of the entity's current location. Accordingly, when supplied with a new trusted location for the entity, the INS may set its trusted initial location to the new trusted location, and use the discrepancy between the new trusted location and the last estimate of the entity's current location to recalibrate the inertial sensors. This process of updating and/or resetting the INS may take place (for example) periodically, at scheduled times, or when the uncertainty associated with the INS estimate of the entity's position exceeds a threshold.

A particular method or system for identifying an entity's location may be more or less accurate than another method or system, depending on the circumstances. For example, a GPS typically provides accurate location information in the absence of interference (e.g., jamming) but lacks the high rate, short-term responsiveness of an inertial navigation system. The INS is typically very responsive in the short term, but is prone to drift over time as small errors in its sensor measurements accumulate. An entity equipped with multiple systems for identifying the entity's location may rely on a navigation filter to blend the inputs of the installed systems to provide positioning estimates that are accurate and robust in the prevailing circumstances.

A navigation filter may be a weighted filter (e.g., a Kalman filter) that provides a statistically optimal estimate of an entity's position by monitoring the positioning data provided by two or more systems for identifying an entity's location and various indicators (e.g., uncertainty or confidence) of the accuracies of those location systems. For example, a GPS receiver may provide the navigation filter with an estimate of the interference associated with the GPS signals. Alternatively or additionally, a GPS receiver may provide the navigation filter with an estimate of the “uncertainty” in the GPS positioning data (e.g., an estimate of the error in the data, or an estimate of confidence in the data). The navigation filter may use the uncertainty estimate provided by the GPS receiver to weight the positioning data provided by the GPS receiver, or use the interference estimate to compute weights for the positioning data. As another example, the navigation filter may compute corrections for the positioning data provided by an inertial navigation system (INS) based on comparison of the INS outputs and the GPS outputs, and may identify error sources within the INS that are likely producing the observed accumulated error in the INS reported position. The navigation filter may then apply a filtering algorithm to the positioning data and the weights to compute a statistically optimal estimate of the entity's position.

When interference with a positioning system's signals results in an unacceptable degree of uncertainty associated with the positioning data provided by the corresponding receiver, the receiver's operation may be adjusted to mitigate the effects of the interference (e.g., to decrease the uncertainty associated with the positioning data). For example, a GNSS (e.g., GPS) receiver may monitor the level of interference associated with GNSS signals. If interference monitoring unit detects unacceptable levels of interference, the GNSS receiver may attempt to mitigate the effects of the interference via beam-steering. Adjusting the direction of the antenna's main lobe (i.e., beam-steering) may reduce the interference.

### SUMMARY

The foregoing is a non-limiting summary of the invention, which is defined by the attached claims.

According to an embodiment of the present disclosure, there is provided a method for obtaining a position of a mobile entity. The method may comprise receiving, with an antenna, first signals associated with a first positioning system and second signals associated with a second positioning system; monitoring the first and second signals for interference; locating a first candidate position of the mobile entity based on the first signals; locating a second candidate position of the mobile entity based on the second signals; and filtering input data to obtain output data, the output data comprising the position of the mobile entity, the input data comprising the first candidate position, the second candidate position, and interference data corresponding to the interference.

In some embodiments of the method, the antenna may be a GNSS antenna.

In some embodiments of the method, the first positioning signals may be broadcast by a first positioning system. In some embodiments of the method, the second positioning signals may be broadcast by a second positioning system.

In some embodiments, the method may further comprise using the interference data to beam-steer the antenna in a direction such that post-steering interference associated with the first signals is less than pre-steering interference associated with the first signals, and/or post-steering interference associated with the second signals is less than pre-steering interference associated with the second signals.

In some embodiments of the method, the output data may further comprise an estimated uncertainty of the position of the mobile entity.

In some embodiments of the method, a first frequency band of the first signals and a second frequency band of the second signals may differ at least in part.

In some embodiments, filtering the input data to obtain the output data may comprise: estimating a first uncertainty of the first candidate position based at least in part on the interference data; estimating a second uncertainty of the second candidate position based at least in part on the interference data; and selecting the first candidate position as the position of the mobile entity if the first uncertainty is less than the second uncertainty.

In some embodiments, the method may further comprise extracting first signal data from the first signals, the first signal data comprising first position data, first bearing data, first range data, and/or first timing data; and extracting second signal data from the second signals, the second signal data comprising second position data, second bearing data, second range data, and/or second timing data.

In some embodiments, the method may further comprise extracting other data from the second signals, the other data comprising command data, control data, targeting data, and/or route data.

According to another embodiment of the present disclosure, there is provided a positioning data apparatus comprising: an antenna; a first receiver coupled to the antenna, the first receiver configured to process first signals received by the antenna, the first signals associated with a first positioning system; a second receiver coupled to the antenna, the second receiver configured to process second signals received by the antenna, the second signals associated with a second positioning system; an interference monitoring unit coupled to the antenna, the interference monitoring unit configured to produce interference data characterizing interference associated with the first and second signals; a first location unit coupled to the first receiver, the first location unit configured to identify a first candidate position of the positioning data apparatus by processing first data associated with the first signals; a second location unit coupled to the second receiver, the second location unit configured to identify a second candidate position of the positioning data apparatus by processing second data associated with the second signals; and a filter coupled to the first location unit, the second location unit, and the interference monitoring unit, the filter configured to process input data to obtain output data, the output data comprising the position of the positioning data apparatus, the input data comprising the first candidate position, the second candidate position, and the interference data.

In some embodiments of the apparatus, the antenna is a GNSS antenna.

In some embodiments of the apparatus, the first positioning system is a GNSS. In some embodiments, the second positioning system is not the GNSS, and the second positioning system provides the second signals via broadcast.

Some embodiments of the apparatus further comprise a beam-steering unit coupled to the first location unit, the second location unit, the interference monitoring unit, and the antenna, the beam-steering unit configured to beam-steer the antenna in a direction such that post-steering interference associated with the first signals is less than pre-steering interference associated with the first signals, and/or post-steering interference associated with the second signals is less than pre-steering interference associated with the second signals.

In some embodiments of the apparatus, the output data further comprises an estimated uncertainty of the position of the positioning data apparatus.

According to another embodiment of the present disclosure, there is provided a navigation system comprising: a guidance unit including a positioning data receiver, a navigation filter, and an inertial navigation system, the navigation filter being coupled to the positioning data receiver and the inertial navigation system.

Some embodiments of the positioning data receiver include: an antenna; a first receiver coupled to the antenna, the first receiver configured to process first signals received by the antenna, the first signals associated with a first positioning system; a second receiver coupled to the antenna, the second receiver configured to process second signals received by the antenna, the second signals associated with a second positioning system; an interference monitoring unit coupled to the antenna, the interference monitoring unit configured to produce interference data characterizing interference associated with the first and second signals; a first location unit coupled to the first receiver, the first location unit configured to identify a first candidate position of the positioning data apparatus by processing first data associated with the first signals; a second location unit coupled to the second receiver, the second location unit configured to identify a second candidate position of the positioning data apparatus by processing second data associated with the second signals; and a filter coupled to the first location unit, the second location unit, and the interference monitoring unit, the filter configured to process input data to obtain output data, the output data comprising the position of the positioning data receiver, the input data comprising the first candidate position, the second candidate position, and the interference data.

Some embodiments of the system further comprise a dynamic navigation unit coupled to the guidance unit.

In some embodiments of the system, the antenna is a GNSS antenna.

In some embodiments of the system, the first positioning system is a GNSS, the second positioning system is not the GNSS, and the second positioning system provides the second signals via broadcast.

Some embodiments of the positioning data receiver further include a beam-steering unit coupled to the first location unit, the second location unit, the interference monitoring unit, and the antenna, the beam-steering unit configured to beam-steer the antenna in a direction such that post-steering interference associated with the first signals is less than pre-steering interference associated with the first signals, and/or post-steering interference associated with the second signals is less than pre-steering interference associated with the second signals.

In some embodiments of the system, the output data further comprises an estimated uncertainty of the position of the positioning data receiver.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a block diagram of an exemplary embodiment of a dynamic navigation unit;

FIG. 2 is a block diagram of an exemplary embodiment of a dynamic navigation model;

FIG. 3 is a schematic illustration of an exemplary embodiment of a dynamic navigation unit;

FIG. 4 is a block diagram of an exemplary embodiment of a guidance unit;

FIG. 5 is a schematic illustration of an exemplary embodiment of a navigation system comprising a dynamic navigation unit and a guidance unit;

FIG. 6 is a schematic illustration of another exemplary embodiment of a navigation system comprising a dynamic navigation unit and a guidance unit;

FIG. 7 is a schematic illustration of another exemplary embodiment of a navigation system comprising a dynamic navigation unit and a guidance unit;

FIG. 8 is a flow chart of an exemplary process of guiding a mobile entity;

FIG. 9 is a flow chart of an exemplary process of updating an inertial navigation system;

FIG. 10 is a flow chart of another exemplary process of guiding a mobile entity;

FIGS. 11A-11B are sketches illustrating how embodiments of a dynamic navigation unit may be used to guide a mobile entity in a region containing one or more areas of uncertain positioning data;

FIG. 11C is a sketch illustrating a mobile entity navigating through an area of uncertain positioning data;

FIGS. 12-13 are a block diagram and a schematic illustration, respectively, of another exemplary embodiment of a guidance unit;

FIG. 14 is a schematic illustration of an embodiment of a positioning data receiver;

FIG. 15 is a schematic illustration of another exemplary embodiment of a navigation system comprising a dynamic navigation unit and a guidance unit;

FIG. 16 is a flow chart of an exemplary process for obtaining a position of a mobile entity;

FIG. 17 is a flow chart of an exemplary process for filtering input data to obtain output data; and

FIG. 18 is a flow chart of another exemplary process for obtaining a position of a mobile entity.

### DETAILED DESCRIPTION

Embodiments of the present disclosure relate generally to methods, systems, and devices for navigating. Some embodiments relate specifically to navigating in circumstances where the operation of a positioning system may be hindered or disrupted by one or more forms of interference.

Interference with the transmission or reception of a positioning system's signals may adversely affect the positioning system's performance (e.g., accuracy or reliability). Sources of interference with a positioning system's operation may include terrain, weather, equipment failure, deliberate signal jamming, use of the positioning system's frequency band by unauthorized devices, excessive use of the positioning system's frequency band by authorized devices, or any other naturally-occurring or man-made object or phenomenon that produces noise or other signals in the positioning system's frequency band or otherwise disrupts, alters, cancels, or dampens the signals transmitted between the positioning system's transmitters and a receiver. Interference may include noise or other signals in or near the frequency band(s) used by the positioning system, whatever the source.

One technique for dealing with interference is pre-excursion routing. Prior to a mobile entity embarking on an excursion through a region of interest, the attributes of a positioning system within the region of interest may be assessed. The presence of interference may be detected, and one or more areas within the region where the positioning system is unlikely to provide suitable positioning data to the mobile entity may be identified. Such an area may be referred to as an “area of uncertain positioning data.” In view of this assessment, a route for the excursion may be proposed. The proposed route may avoid the area(s) of uncertain positioning data in whole or in part. Even if a proposed route fails to entirely avoid the area(s) of uncertain positioning data, there may nevertheless be a reasonable expectation of obtaining accurate positioning data while within the area(s) of uncertain positioning data. For example, if the portion of the route that passes through an area of uncertain positioning data is not excessively long, an inertial navigation system (INS) may reasonably be expected to provide sufficiently accurate positioning data along that portion of the route. As another example, even if a mobile entity traveling in an area of uncertain positioning data is unlikely to obtain accurate positioning data via a given positioning system, such as the GPS, analysis may indicate that the entity is likely to obtain accurate positioning data via another positioning system, such as a system that provides positioning signals over a data link, while traveling in the area. As yet another example, an analysis of interference in the area of uncertain positioning data may indicate that appropriate beam-steering of the antenna of a positioning system receiver will allow the receiver to obtain sufficiently accurate positioning data within the area.

Another technique for dealing with interference is reactive mitigation. After a mobile entity embarks on an excursion through a region of interest, the mobile entity may enter an area where a given positioning system fails to provide suitable positioning data. In response, the mobile entity may activate an alternative means of navigation. For example, if GPS is the preferred positioning system but the mobile entity enters an area of uncertain GPS data, the mobile entity may activate the inertial navigational system (INS) or may rely on an alternative positioning system, such as a system that provides positioning signals over a data link. Additionally or alternatively, beam-steering the antenna of the GPS receiver may allow it to obtain sufficiently accurate positioning data within the area.

The inventors have recognized and appreciated that pre-excursion routing and reactive mitigation may not adequately address the problems that arise in circumstances where the operation of a positioning system is hindered or disrupted by one or more forms of interference. For example, pre-excursion routing may be ineffectual in circumstances where positioning system attributes or interference conditions change during an excursion. The activation or deactivation of one or more transmitters of the positioning system may alter the positioning system's coverage, accuracy, reliability, signal strength, etc. within the region. Likewise, a wide variety of events may cause the location, frequency, intensity, coverage, etc. of interference to change during the excursion. Such changes in the positioning system attributes or interference conditions may cause long segments of the selected route to pass through areas of uncertain positioning data.

Conventional reactive mitigation techniques may not adequately remedy the shortcomings of pre-excursion routing. As described above, a mobile entity that enters an area of uncertain positioning data may activate its INS. While navigating by INS may be suitable for short periods of time, the INS estimate of the mobile entity's location may drift over time as small errors in INS sensor measurements accumulate. Thus, if a long segment of the selected route falls within an area of uncertain positioning data, the errors in the location information provided by the INS may become intolerably large before the mobile entity is able to acquire a new trusted initial position and reset its INS. Likewise, in circumstances where interference is sufficiently strong and/or pervasive, even a positioning system receiver with a beam-steered antenna may be unable to obtain sufficiently accurate positioning data.

Furthermore, some conventional reactive mitigation techniques may be impractical, at least under some circumstances. As described above, a mobile entity that enters an area in which one positioning system (e.g., the GPS) is unable to provide accurate positioning data may rely on an alternative positioning system, such as a system that provides positioning signals over a data link. However, data link equipment may be large and heavy, and may require large amounts of electrical power. As another example, a mobile entity equipped with appropriate data link equipment may be unable to reactively establish sufficient contact with external systems to obtain accurate positioning information. Accordingly, relying on a data link for reactive mitigation may be infeasible, particularly when the mobile entity's size, weight, or power storage capacity is constrained.

Thus, practical techniques are needed for navigating in circumstances where the operation of a positioning system may be hindered or disrupted by interference. The inventors have recognized and appreciated that the performance of a mobile entity's navigation and guidance systems may be enhanced if the mobile entity collects navigation data (e.g., GPS signal interference data associated with an area) from one or more remote data sources and responds to such navigation data proactively (e.g., by initiating a mitigation action in response to obtaining such navigation data, even if the mobile entity is not in position to confirm such navigation data with its own sensors). The inventors have also recognized and appreciated that the performance of a mobile entity's navigation and guidance systems may be enhanced if a common antenna is used to receive signals associated with two positioning systems.

Proactive Mitigation with Respect to Areas of Uncertain Positioning Data

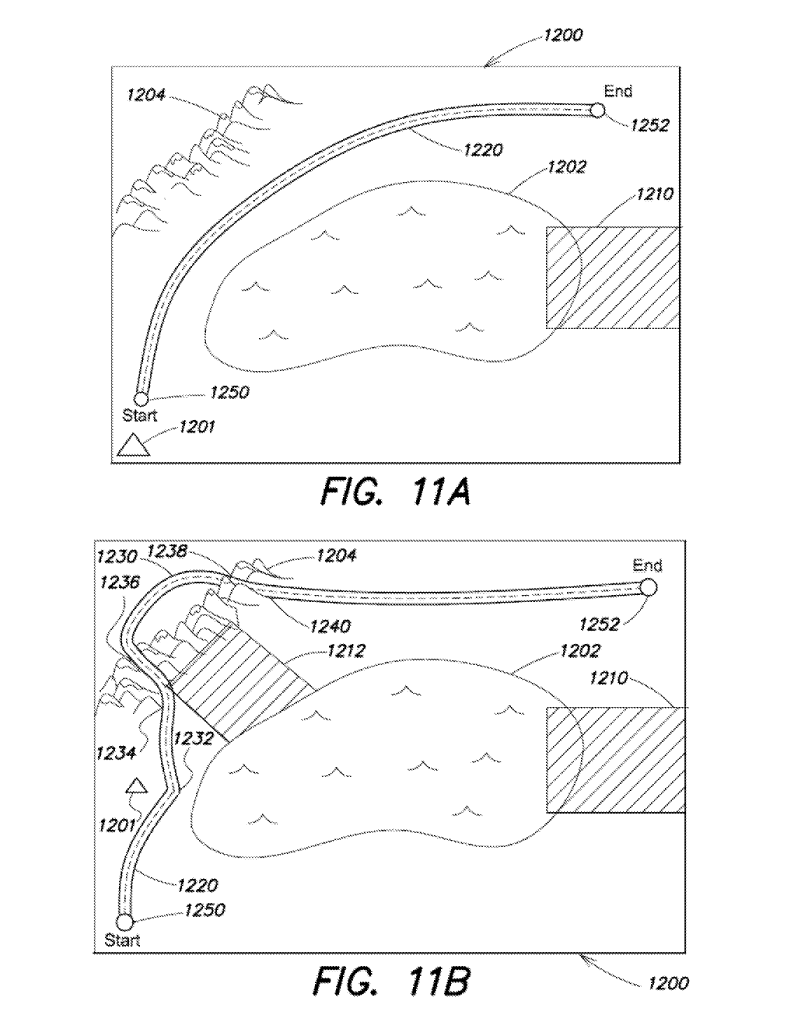

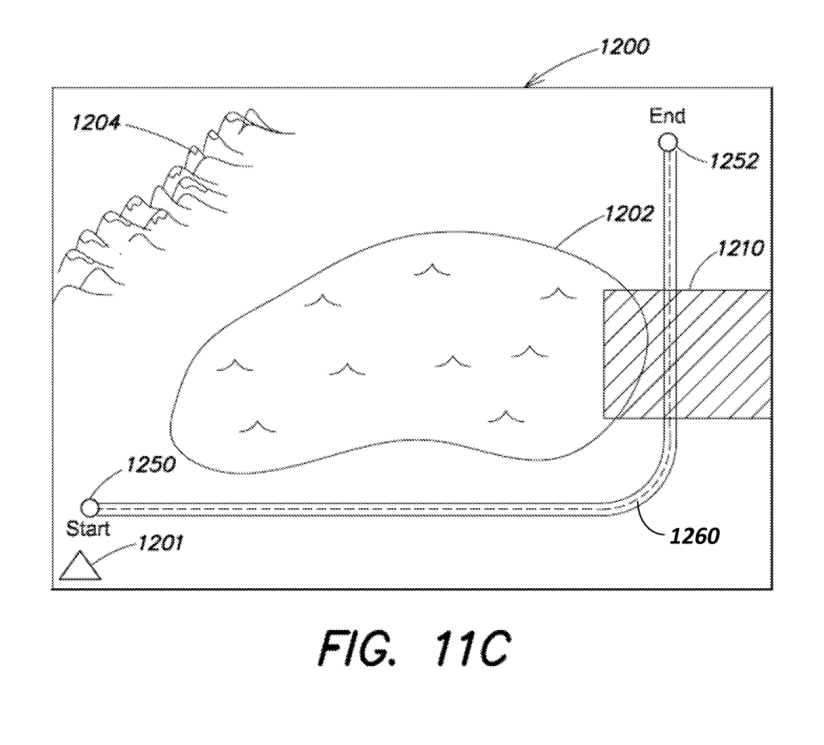

FIGS. 11A-11B illustrate how embodiments of a dynamic navigation model and a proactive mitigation technique may be used for navigation and guidance in a region containing areas of uncertain positioning data, such as areas associated with interference. FIG. 11A illustrates a region of interest 1200 containing a lake 1202 and a mountain range 1204. Most areas of the region 1200 reliably receive strong signals transmitted by GPS satellites (not illustrated). However, GPS reception in the mountain range 1204 is weak and unreliable. In addition, a signal jammer interferes with GPS signals in area 1210. Accordingly, mountain range 1204 and area 1210 are both areas of uncertain positioning data.

In the illustration of FIG. 11A, a land route 1220 for an excursion from starting location 1250 to ending location 1252 has been identified. The land route 1220 avoids areas that may be unsuitable or unsafe for a land-based mobile entity 1201, such as lake 1202 and mountain range 1204. In addition, no portion of the route 1220 passes through an area of uncertain positioning data. Thus, it is expected that a mobile entity 1201 equipped with a GPS receiver will reliably receive strong and accurate GPS positioning data throughout an excursion along route 1220.

FIG. 11B illustrates the region of interest 1200 at a time when the mobile entity 1201 has arrived at location 1232 along route 1220. In the illustration, the mobile entity 1201 has acquired data indicating that there is heavy interference with GPS signals in area 1212. In the illustration, the mobile entity 1201 may have acquired this data from sensors associated with the mobile entity 1201, or received this data from a remote data source. Whatever the source of the data, the illustrated mobile entity 1201 may integrate the data into an embodiment of a dynamic navigation model of the region 1200, which may already include data regarding the lake 1202, mountain range 1204, area of uncertain positioning data 1210, and other relevant features of the region 1200. In the illustration, the mobile entity 1201 may process the embodiment of the dynamic navigation model (not illustrated) to identify a new route 1230 from current location 1232 to ending location 1252. The illustrated route 1230 avoids the large area of uncertain positioning data 1212 by crossing the mountain range between locations 1234 and 1236, and re-crossing the mountain range between locations 1238 and 1240.

As described above, the mobile entity 1201 may use an embodiment of a dynamic navigation model to adjust its route, thereby avoid the newly-discovered area of uncertain positioning data 1212. In addition, the mobile entity 1201 may identify proactive mitigation actions which may reduce the navigational uncertainty caused by travelling through areas of uncertain positioning data, such as the mountain passes 1234-1236 and 1238-1240. For example, the mobile entity may schedule resets of its inertial navigation system (INS) to occur at locations 1234 and 1238 (i.e., just before entering the mountain passes 1234-1236 and 1238-1240, at locations where GPS reception is likely to be adequate). By resetting the INS with reliable GPS positioning data just before entering areas of unreliable positioning data, the mobile entity 1201 may reduce the cumulative errors in the positioning estimates generated by the INS during the periods when the mobile entity 1201 passes through the areas of uncertain positioning data. By contrast, in the absence of such proactive mitigation, the INS might attempt a scheduled or periodic update shortly after the mobile entity enters an area of uncertain positioning data. Upon the failure of such an attempt, an operator of the mobile entity might be forced to backtrack out of the area of uncertain positioning data, or proceed through the area of uncertain positioning data despite low confidence in the accuracy of the INS positioning data.

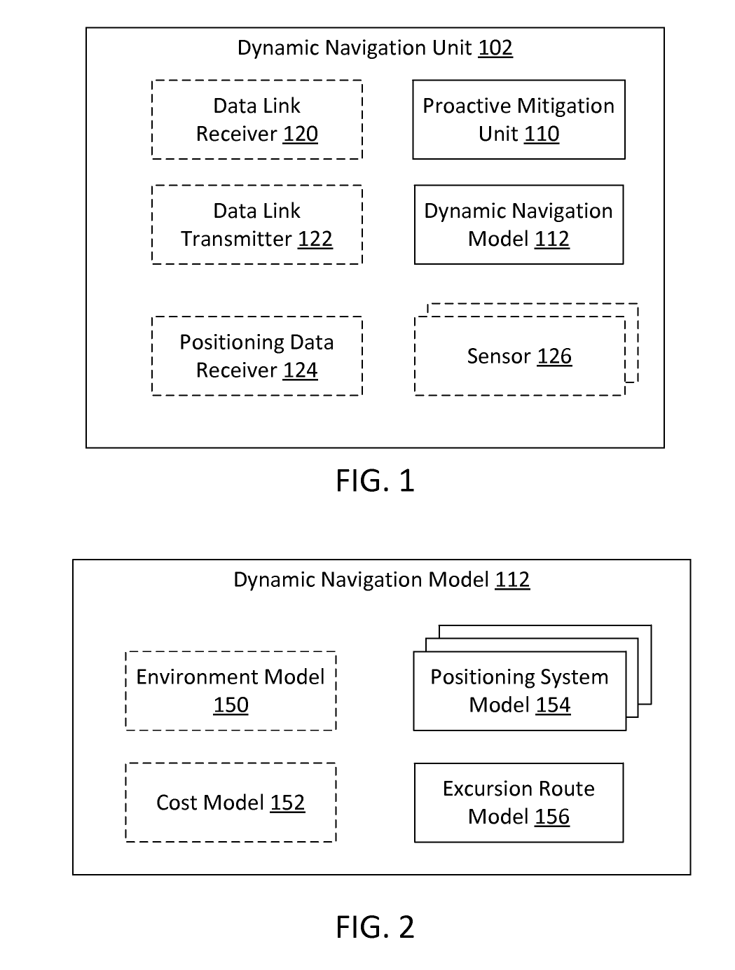

FIG. 1 is a block diagram of an exemplary embodiment of a dynamic navigation unit 102. In the example of FIG. 1, the dynamic navigation unit 102 comprises a proactive mitigation unit 110 and a dynamic navigation model 112. The dynamic navigation unit 102 may also comprise a data link receiver 120, a data link transmitter 122, a positioning data receiver 124, and/or one or more sensors 126.

In some embodiments, data link transmitter 122 and receiver 120 may send and receive data over a data link. Any means of communicating data over a data link known to one of ordinary skill in the art or suitable for the purpose of communicating data over a data link may be used. Embodiments are not limited in this regard. In some embodiments, data communicated over the data link may comprise timing, ranging, bearing, and/or positioning data. In some embodiments, data communicated over the data link may comprise data from which the position of a mobile entity can be triangulated, trilaterated, or multilaterated. In some embodiments, the communicated data may comprise any data that might be relevant to navigating a mobile entity or identifying a position of a mobile entity. For example, the communicated data may comprise data characterizing a region of interest, such as a portion of a dynamic navigation model 112 or data that could be integrated into a dynamic navigation model 112. In some embodiments, the transmitted data may comprise measurements, observations, estimates, predictions, command and control data, targeting data, routing data, acknowledgments, etc.

In some embodiments, data link transmitter 122 and receiver 120 may be used to exchange data with one or more remote data sources. In some embodiments, a remote data source may be any entity that is remote from data link transmitter 122 and receiver 120 and is equipped to communicate over a data link. In some embodiments, a remote data source may comprise a device associated with another mobile entity in or near the region of interest. For example, a remote data source may comprise a dynamic navigation unit controlled by or associated with a mobile entity. In some embodiments, a remote data source may comprise any device storing data relevant to navigating a mobile entity or identifying a position of a mobile entity, irrespective of the device's mobility or location, and irrespective of how the device acquired the data. For example, a remote data source may comprise a server or a satellite.

Some embodiments of dynamic navigation unit 102 may comprise a positioning data receiver 124. A positioning data receiver may comprise any device configured to receive signals transmitted by a positioning system and process those signals to identify a location of the positioning data receiver. For example, a positioning data receiver may comprise a GPS receiver, a GLONASS receiver, or any conventional positioning data receiver known to one of ordinary skill in the art. Additional embodiments of a positioning data receiver 124 are described in this disclosure.

Some embodiments of dynamic navigation unit 102 may comprise one or more sensors 126. Embodiments of sensor 126 may be active or passive. Embodiments of sensor 126 may detect attributes of a region of interest, such as characteristics of positioning system signals or interference (e.g., strength, bandwidth, coverage, etc.), weather conditions (e.g., wind speed and direction, temperature, etc.), geo-spatial conditions, or hazards (e.g., weapons, explosive devices, etc.). In some embodiments, data collected from sensors 126 may be integrated into dynamic navigation model 112 and/or transmitted to one or more remote devices via data link transmitter 122.

In the example of FIG. 1, the dynamic navigation unit 102 comprises a dynamic navigation model 112. An embodiment of a dynamic navigation model 112 may comprise data stored on a computer-readable storage device (e.g., a data set or a database). An embodiment of a dynamic navigation model 112 may further comprise instructions stored on a computer-readable storage device which, when executed by a processor, provide access to the data.

In some embodiments, the data of a dynamic navigation model 112 may be relevant to navigating in a region of interest. In some embodiments, at least some of the data of a dynamic navigation model 112 may be derived from publicly available resources, such as maps, acquired via surveillance techniques, or acquired by any other means known to one or ordinary skill in the art or suitable for the acquisition of such data. In some embodiments, at least some of the data of a dynamic navigation model 112 may be derived from data received via data link receiver 120, sensor(s) 126, or other suitable means.

In some embodiments, a dynamic navigation model 112 associated with a mobile entity may comprise only data acquired and processed prior to the mobile entity embarking on an excursion in the region of interest. In some embodiments, a dynamic navigation model 112 may be constructed externally to the dynamic navigation unit 102 (e.g., by a computer) and provided to the dynamic navigation unit 102 (e.g., as one or more data structures and/or programs suitable for storage in a storage medium of the dynamic navigation unit 102).

In some embodiments, a dynamic navigation model 112 may comprise data acquired or processed after the mobile entity embarks on an excursion in the region of interest. By integrating data into the dynamic navigation model 112 during an excursion, such embodiments may adapt the dynamic navigation model 112 to reflect changes in the conditions of the region of interest that occur or are discovered during an excursion. Integrating data into a dynamic navigation model 112 during an excursion may comprise updating an existing dynamic navigation model or constructing a new model to replace the existing model. In some embodiments, the updating may be performed by the dynamic navigation unit 102. In some embodiments, the updating may be performed by another device and the updated model may be communicated to the dynamic navigation unit 102.

For example, in some embodiments an initial dynamic navigation model 112 may be provided to the dynamic navigation unit 102. Additionally or alternatively, some embodiments of the dynamic navigation unit 102 may integrate data received via data link receiver 120, positioning data receiver 124, sensor(s) 126, or any other suitable means into dynamic navigation model 112. In some embodiments, dynamic navigation unit 102 may process the data received data to obtain new data, and integrate the new data into dynamic navigational model 112. For example, in some embodiments, if a dynamic navigation unit 102 receives data indicating the presence of strong signal interference in a particular area, the dynamic navigation unit 102 may apply suitable methods to predict the signal interference conditions in neighboring areas.

In some embodiments, the dynamic navigation unit 102 may integrate new data into the dynamic navigation model 112 in response to receiving or processing the data. In some embodiments, the dynamic navigation unit 102 may integrate new data into the dynamic navigation model 112 periodically, at specified times, or in response to receiving an integration command.

FIG. 2 is a block diagram of an exemplary embodiment of a dynamic navigation model 112. In the example of FIG. 2, the dynamic navigation model 112 comprises one or more positioning system models 154 and an excursion route model 156. A dynamic navigation model 112 may also comprise an environment model 150 and/or a cost model 152.

Some embodiments of environment model 150 may include data regarding an environment of a region of interest, such as data pertaining to terrain, landmarks, roads, paths, waterways, airspace, climate, or weather of the region. In some embodiments an environment model 150 may also include data regarding an environment of a region adjacent to a region of interest.

Some embodiments of cost model 152 may include data related to excursion constraints. Excursion constraints may relate to time (e.g., reaching the destination at a particular time, prior to a particular time, within a certain time period after commencing movement, or as soon as possible), terrain (e.g., travelling by ground, water, air, or road), safety (e.g., avoiding areas regarded as hazardous to the entity), or other considerations known to one of ordinary skill in the art. For example, if safety is among the constraints, a cost model 152 may identify an area within the region that is highly unsafe or identify a safety level of an area in accordance with safety criteria. As another example, a cost model 152 may include information regarding known or anticipated hazards in the region, such as a description of the hazard and the hazard's location.

In some embodiments, a cost model 152 may associate one or more areas of the region with one or more respective cost quantities or cost functions. In some embodiments, such cost quantities or functions may be specified by a user. In some embodiments, such cost quantities or functions may be computed based on default or user-specified preferences or constraints. For example, if a user specifies a preference for fuel or energy economy, cost model 152 may associate lower costs with routes that are more conducive to energy-efficient or fuel-efficient travel, such as shorter routes, routes with low congestion, routes with few required stops (e.g. for traffic signs or signals), and routes over flat terrain. In this manner, the cost model may assist the user in selecting a route that reduces or minimizes the fuel or energy expended by the mobile entity in moving from one location to another. As another example, cost model 152 may assign a cost to a route based at least in part on the route's proximity to one or more refueling stations equipped to provide a type of fuel or energy specified by the user. In many areas, refueling stations may be sparse or non-existent, particularly for alternative vehicles (e.g., electric cars, hybrids, or any vehicle that does not use gasoline as its primary fuel). Assigning costs to routes based on proximity to appropriate refueling stations may assist drivers in identifying routes that reduce or minimize the risk of running out of fuel during an excursion. As another example, if a user prefers traveling on interstate highways or freeways over traveling on state roads, country roads, or city streets, a cost model 152 may associate a low-cost function with portions of the region containing interstate highways or freeways, and associate a high-cost function with portions of the region containing other types of roads. As another example, if a user expresses a desire to complete an excursion quickly, a cost model 152 may associate a cost function with an area of the region that varies inversely with the speed of travel through the area (e.g., assigns a low cost to areas where high-speed travel is feasible, and assigns a high cost to areas where high-speed travel is not feasible).

A computing device, such as an embodiment of dynamic navigation unit 102, may use a cost model 152 to identify a route through a region of interest that satisfies one or more cost criteria. For example, an embodiment of dynamic navigation unit 102 may use a cost model 152 to identify a shortest route between two locations, a fastest route between two locations, or a route that permits completion of an excursion between two locations without entering hazardous areas and/or areas of uncertain positioning data.

Some embodiments of positioning system model 154 may include data relating to a positioning system, such as a positioning system that provides positioning data to at least a portion of the region of interest. The accuracy and/or reliability of a positioning system may vary at different locations within a region. For example, a positioning system may reliably provide accurate location information throughout a region of interest, with the exception of a few areas, such as a valley surrounded by steep mountains (which may not be reliably reached by signals from the positioning system's transmitters). In some embodiments, a positioning system model may include data regarding the attributes of the corresponding positioning system (e.g., coverage, reliability, accuracy, signal strength, etc.) at some or all areas within the region.

In some embodiments, a positioning system model 154 may include data relating to interference with the signals of the corresponding positioning system, such as interference that is known or predicted to exist at areas within the region of interest. The sources and characteristics of interference may vary at different locations within a region. In some embodiments, data relating to interference and data relating to the positioning system's performance in the absence of interference may be integrated into a unified model of the positioning system's operation in the presence of the interference (e.g., by adjusting the data regarding coverage, reliability, accuracy, signal strength, etc. of the positioning system to reflect the effects of the known or predicted interference). In some embodiments, data relating to interference may be maintained separately from data relating to the positioning system's performance in the absence of interference. In some embodiments, the positioning system model 154 may store data relating to interference, but not data relating to the positioning system's performance in the absence of interference.

Some embodiments of excursion route model 156 may include data relating to one or more routes through the region of interest, such as routes that satisfy one or more cost criteria or constraints. For example, excursion route model 156 may include data relating to a route identified by processing of the a cost model 152. In some embodiments, the data relating to a route may include data identifying the route, such as a sequence of positions that would be attained by a mobile entity traveling along the route, or a sequence of directions which, if followed by a mobile entity, would guide the mobile entity along the route.

In some embodiments, excursion route model 156 may include data identifying a positioning system (e.g., GPS) or navigational system (e.g., INS) that is likely to provide the most reliable and/or accurate positioning data along one or more portions of the route. In some embodiments, such data may be derived by processing one or more positioning system model(s) 154.

In accordance with the foregoing, a dynamic navigation unit 102 may comprise a dynamic navigation model 112. Embodiments of a dynamic navigation model 112 may include data relevant to navigation and/or guidance in a region of interest, such as an environment model 150, a cost model 152, one or more positioning system models 154, and an excursion route model 156. In some embodiments, the dynamic navigation model 112 may be updated during an excursion to include data acquired or received during the excursion. In this manner, a dynamic navigation model 112 may change over time to reflect corresponding changes in conditions within the region of interest.

Returning to the example of FIG. 1, embodiments of a dynamic navigation unit 102 may comprise a proactive mitigation unit 110. Some embodiments of proactive mitigation unit 110 may predict an uncertainty of positioning data in an area. The area may be an area that includes the dynamic navigation unit 102, an area that includes the mobile entity associated with the dynamic navigation unit 102, or any other area in a region of interest.

Predicting an uncertainty of positioning data in an area may comprise estimating a probability that a positioning data receiver 124 located within the area would reliably receive accurate positioning data from a corresponding positioning system. In some embodiments, proactive mitigation unit 110 may predict an uncertainty of positioning data using one or more metrics such as average or median uncertainty throughout the area, maximum or minimum uncertainty at any location in the area, etc. In some embodiments, proactive mitigation unit 110 may identify one or more portions of an area in which the predicted uncertainty of positioning data is greater than (or less than) a specified threshold. In some embodiments, proactive mitigation unit 110 may treat reception of accurate positioning data as “reliable” if the accurate positioning data is received (or predicted to be received) at a rate exceeding a specified threshold. In some embodiments, a reliability threshold may be expressed in units of kilobytes per second, coordinates per minute, etc.

Predicting an uncertainty of positioning data in an area may comprise analyzing data related to the positioning system, the positioning data receiver, the terrain of the area (or nearby terrain), the weather, interference, etc. In some embodiments, proactive mitigation unit 110 may use data obtained from dynamic navigation model 112 to predict an uncertainty of positioning data in an area. For example, some embodiments of proactive mitigation unit 110 use a positioning system model 154 associated with dynamic navigation model 112 to predict an uncertainty of positioning data provided by a corresponding positioning system. Thus, dynamically updating dynamic navigation model 112 during an excursion based on data acquired during the excursion, may enhance the accuracy of such predictions made by proactive mitigation unit 110.

Some embodiments of proactive mitigation unit 110 may predict traffic conditions in an area, such as presence or absence of congestion, prevailing speed of traffic, time until a mobile entity travels through a bottleneck, time until a traffic jam dissipates, etc. Such predictions may be based on sensor readings and/or crowd-sourced data received from remote data sources, such as other mobile entities.

Navigating a mobile entity in an area where the positioning data is uncertain may, in some cases, have a negative impact on the mobile entity. For example, the mobile entity may be delayed, be unable to follow a specified route, become lost, inadvertently enter an unsafe area, etc. In some embodiments, proactive mitigation unit 110 may proactively mitigate the potential difficulties associated with traveling in an area of uncertain positioning data by recommending or initiating one or more mitigation actions when a mobile entity is outside the area of uncertain positioning data.

In some embodiments, the mitigation actions recommended or initiated by the proactive mitigation unit 110 may comprise rerouting the mobile entity (e.g., to a route that does not pass through the area of uncertain positioning data or covers a shorter distance within the area of uncertain positioning data). In some embodiments, the mitigation actions may comprise updating the inertial navigation system (e.g., updating the trusted inertial navigation position, resetting the inertial navigation system, and/or recalibrating the inertial navigation sensors). In some embodiments, the mitigation actions may comprise alerting an operator of the mobile entity regarding the area of uncertain positioning data.

Likewise, traveling in an area of adverse traffic conditions may have a negative impact on the mobile entity, such as accident or delay. In some embodiments, proactive mitigation unit 110 proactively mitigates the potential impact of traveling in an area of adverse traffic conditions by recommending or initiating one or more mitigation actions, such as rerouting the mobile entity or alerting an operator of the mobile entity regarding the predicted adverse traffic conditions.

In some embodiments, proactive mitigation unit 110 may recommend or initiate a particular proactive mitigation action when corresponding mitigation criteria are satisfied. For example, proactive mitigation unit 110 may recommend or initiate rerouting only if a new route is predicted to be superior to an existing route. In some embodiments, proactive mitigation unit 110 may compare one or more metrics to predict whether one route is superior to another, such as the number of areas of uncertain positioning data traversed by each route, the total distance each route travels through areas of uncertain positioning data, the total uncertainty of each route (where the total uncertainty of a route is, for example, the integral of a function U(L) over the length of the route (with U(L) being the predicted uncertainty of the positioning data at location L along the route), the total length of each route, the expected time required to travel each route, other hazards or safety conditions associated with each route, etc. In some embodiments, proactive mitigation unit 110 may assign a route a score based on such metrics. In some embodiments, proactive mitigation unit 110 may recommend or initiate a new route if the new route's score exceeds the existing route's score, if the new route's score exceeds the existing route's score by a specified margin, or if the new route's score exceeds a specified threshold.

Likewise, embodiments of proactive mitigation unit 110 may recommend or initiate updating the INS if a route that passes through an area of uncertain positioning data is selected. If the mobile entity proceeds along a route that passes through an area of uncertain positioning data, proactive mitigation unit 110 may recommend or initiate an update of the INS when the mobile entity reaches a location along the route that is near, but not within, the area of uncertain positioning data. By recommending or initiating an update of the INS just before the mobile entity enters the area of uncertain positioning data, proactive mitigation unit 110 may reduce or minimize the accumulated error in the INS estimate of the entity's location while the entity remains within the area of uncertain positioning data.

Embodiments of proactive mitigation unit 110 may alert an operator of the mobile entity regarding a predicted uncertainty of positioning data in an area if the selected route passes through an area of predicted uncertainty in positioning data, if the mobile entity unexpectedly enters an area in which positioning data is uncertain, or if the operator rejects a recommendation of the proactive mitigation unit 110 regarding rerouting.

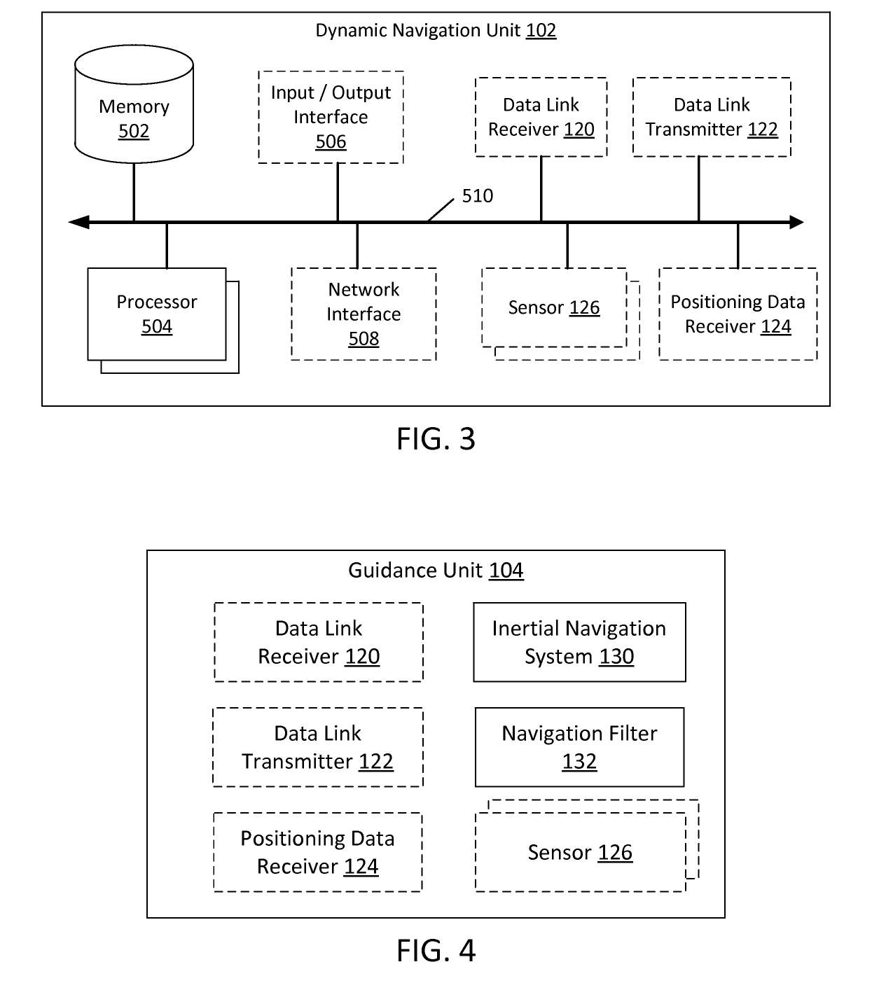

FIG. 3 is a schematic illustration of an exemplary embodiment of a dynamic navigation unit 102. The exemplary dynamic navigation unit 102 of FIG. 3 comprises a memory 502 and one or more processors 504 coupled to a communication bus 510. The memory may be random-access memory (RAM), read-only memory (ROM), disc-based memory, solid-state memory, or any other device known to one of ordinary skill in the art or otherwise suitable for storing instructions and/or data in a non-transient manner. The memory 502 may store instructions which, when executed by the one or more processors 504, cause the one or more processors to perform the functions of a proactive mitigation unit 110 and/or a dynamic navigation model 112. An embodiment of a dynamic navigation model 112 may comprise data stored in memory 502 and/or instructions stored in memory 502 which, when executed by a processor, provide access to the data.

In some embodiments, dynamic navigation unit 102 may further comprise data link receiver 120, data link transmitter 122, and/or positioning data receiver 124. In some embodiments, components 120-124 may be coupled to communication bus 510. In some embodiments, components 120-124 may be coupled to an interface, such as network interface 508. Embodiments are not limited in this regard. In some embodiments, dynamic navigation unit 102 may comprise one or more sensors 126. In some embodiments, sensor(s) 126 may be coupled to communication bus 510. In some embodiments, sensor(s) 126 may be coupled to an interface, such as input/output interface 506. Embodiments are not limited in this regard. In some embodiments, processor(s) 504 may control data exchange among the various components of dynamic navigation unit 102.

FIG. 4 is a block diagram of an exemplary embodiment of a guidance unit 104. Embodiments of guidance unit 104 may guide movement of a mobile entity (e.g., by sending signals to a control unit that controls velocity, acceleration, route, steering, etc.). In some embodiments, dynamic navigation unit 102 may send data to guidance unit 104. In some embodiments, guidance unit 104 may send data to dynamic navigation unit 102. Embodiments of guidance unit 104 may be located on, located in, or attached to the mobile entity.

In the example of FIG. 4, guidance unit 104 comprises an inertial navigation system (INS) 130 and a navigation filter 132, which may be implemented by means known to one of ordinary skill in the art or by any other suitable means. Embodiments of guidance unit 104 may also comprise a data link receiver 120, a data link transmitter 122, a positioning data receiver 124, and/or one or more sensors 126. Components 120-126 are described above. In some embodiments, guidance unit 104 and dynamic navigation unit 102 may divide components 120-126 such that each of components 120-126 is included in either the guidance unit 104 or the dynamic navigation unit 102, but not both, thereby reducing bulk and cost of implementation. In some embodiments, both guidance unit 104 and dynamic navigation unit 102 may comprise one or more of respective components 120-126, thereby increasing reliability through redundancy.

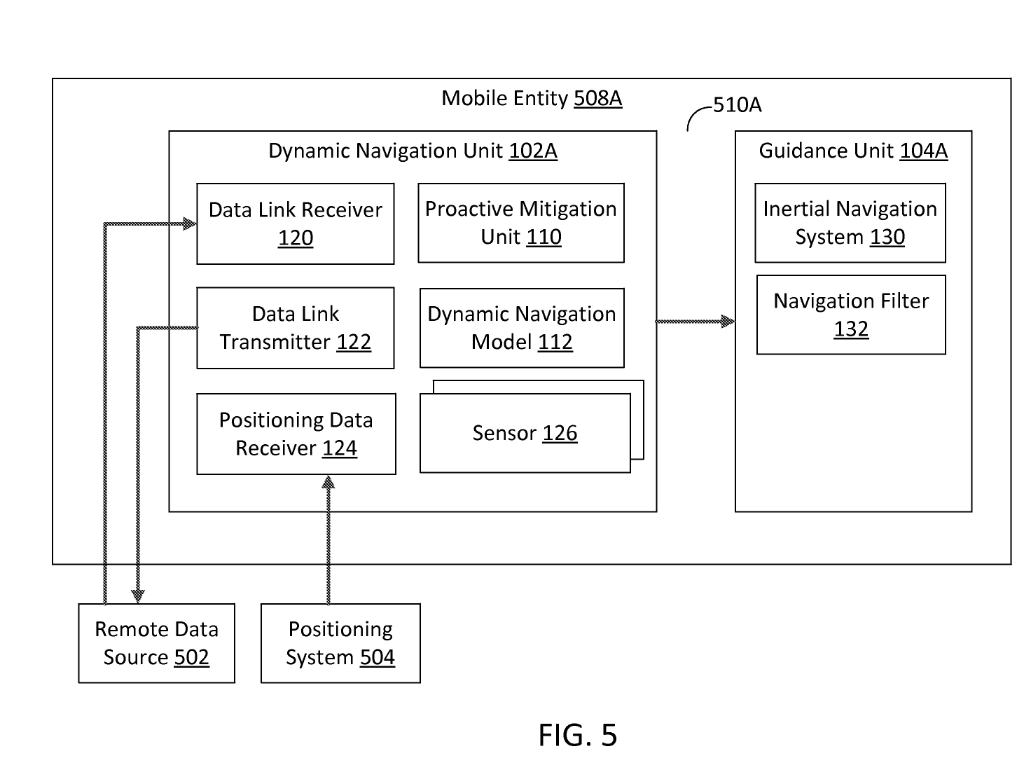

FIG. 5 is a schematic illustration of an exemplary embodiment 510A of a navigation system. The exemplary navigation system 510A comprises an embodiment 102A of a dynamic navigation unit and an embodiment 104A of a guidance unit. In exemplary navigation system 510A, the dynamic navigation unit 102A and the guidance unit 104A are both located on, located in, or attached to a mobile entity 508A.

In the embodiment of FIG. 5, dynamic navigation unit 102A of exemplary navigation system 510A comprises data link receiver 120, data link transmitter 122, positioning data receiver 124, one or more sensors 126, proactive mitigation unit 110, and dynamic navigation model 112. As described above, data link receiver 120 and transmitter 122 are configured to communicate with one or more remote data sources 502. Also as described above, embodiments of positioning data receiver 124 are configured to receive positioning data from positioning system 504. Co-locating dynamic navigation unit 102A with mobile entity 508A ensures that the positioning data received by positioning data receiver 124 is positioning data of the mobile entity 508A.

In the embodiment of FIG. 5, dynamic navigation unit 102A is configured to send data to guidance unit 104A. For example, dynamic navigation unit 102A may send some or all of the data received via data link receiver 120, positioning data received via positioning data receiver 124, and/or sensor data obtained via sensor(s) 126 to guidance unit 104A. Additionally or alternatively, dynamic navigation unit 102A may process data obtained via data link receiver 120, positioning data receiver 124, and/or sensor(s) 126 to produce further data, and send some or all of the further data to guidance unit 104A. Additionally or alternatively, dynamic navigation unit 102A may send guidance unit 104A data provided by proactive mitigation unit 110, such as data relating to a predicted uncertainty of positioning data in an area, and/or a recommendation or instruction to initiate a proactive mitigation action, such as beginning to follow a new route, updating an inertial navigation system (INS) 130, or alerting an operator regarding uncertainty of positioning data. Additionally or alternatively, dynamic navigation unit 102A may send some or all data of dynamic navigation model 112 to guidance unit 104A. In some embodiments, dynamic navigation unit 102A may send data to remote data source(s) 502 via data link transmitter 122.

The guidance unit 104A of exemplary navigation system 510A comprises inertial navigation system 130. As described above, inertial navigation system 130 may estimate an entity's location based on a trusted initial location and data collected from inertial sensors. In some embodiments, the trusted initial location may be supplied to the INS by dynamic navigation unit 102A based on, for example, data obtained via data link receiver 120, positioning data receiver 124, and/or sensor(s) 126. Alternatively or additionally, the trusted initial location may be supplied to the INS by navigation filter 132. As further described above, the INS is configured to use measurements provided by its inertial sensors to estimate the estimate the entity's velocity and position as the entity moves. When supplied with a new trusted location for the entity, the INS may reset itself and/or recalibrate the inertial sensors. In some embodiments, an instruction to reset or recalibrate INS 130 may be issued by dynamic navigation unit 102A, navigation filter 132, and/or an operator of mobile entity 508A.

The guidance unit 104A of exemplary navigation system 510A comprises an embodiment of navigation filter 132. Some embodiments of navigation filter 132 process navigation data, positioning data, and/or data related to the accuracies of one or more systems for identifying an entity's location to identify a position of mobile entity 508A. Embodiments may provide estimates of the mobile entity's position that are accurate and robust by blending positioning data provided by various location systems (e.g., GPS and INS) based on inputs associated with the location systems (e.g., data obtained from a dynamic navigation model). In some embodiments, navigation filter 132 processes data from proactive mitigation unit 110 and/or dynamic navigation model 112 to estimate one or more respective accuracies of one or more location systems of mobile entity 508A under conditions of interest, such as conditions in the area surrounding the mobile entity or in another area of interest. In some embodiments, navigation filter 132 may process data from positioning data receiver 124 and/or sensor(s) 126. In some embodiments, navigation filter 132 may determine whether to follow a recommendation issued by proactive mitigation unit 110 (e.g., a recommendation to change course or update INS 130) based on results of its data processing.

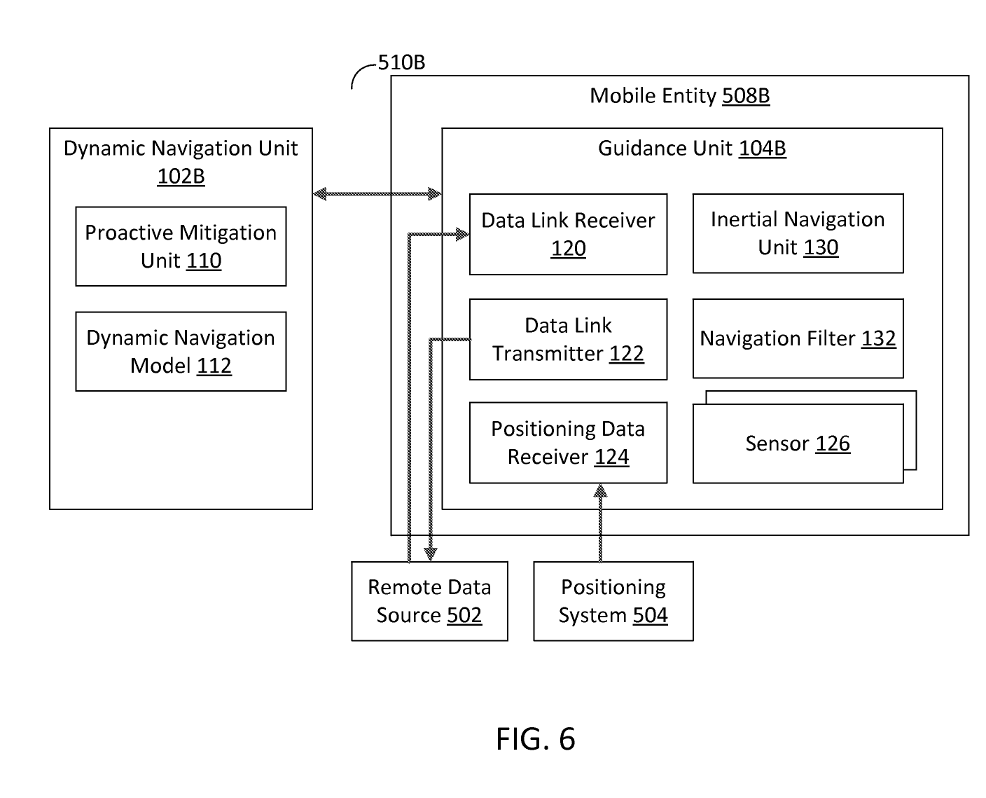

FIG. 6 is a schematic illustration of another exemplary embodiment 510B of a navigation system. The exemplary navigation system 510B comprises an embodiment 102B of a dynamic navigation unit and an embodiment 104B of a guidance unit. In exemplary navigation system 510B, the guidance unit 104B is located on, located in, or attached to a mobile entity 508B. Dynamic navigation unit 102B may be co-located with or remote from mobile entity 508B.

In the embodiment of FIG. 6, dynamic navigation unit 102B of exemplary navigation system 510B comprises proactive mitigation unit 110 and dynamic navigation model 112, while guidance unit 104B comprises data link receiver 120, data link transmitter 122, positioning data receiver 124, sensor(s) 126, INS 130, and navigation filter 132. Exemplary embodiments of these components are described above and will not be discussed further here.

Locating dynamic unit 102B remotely from mobile entity 508B may be advantageous in some circumstances. For example, if some of the data contained in dynamic navigation model 112 is valuable or confidential, keeping dynamic navigation unit 102B at a secure remote location (rather than allowing the dynamic navigation unit 102B to travel with mobile entity 508B) may be preferable. Locating dynamic unit 102B remotely from mobile entity 508B does not affect the accuracy of any positional data, because data link receiver 120 and transmitter 122, positioning data receiver 124, and sensor(s) 126 are co-located with mobile entity 508B.

When dynamic navigation unit 102B is located remotely from mobile entity 508B, guidance unit 104B may send data to dynamic navigation unit 102B, such as some or all of the data obtained via data link receiver 120, positioning data receiver 124, and/or sensor(s) 126. Additionally or alternatively, guidance unit 104B may process data obtained via data link receiver 120, positioning data receiver 124, and/or sensor(s) 126 to produce further data, and send some or all of the further data to dynamic navigation unit 102B. In some embodiments, guidance unit 104B may send data to dynamic navigation unit 102B via any communication means known to one of ordinary skill in the art or suitable for communicating such data.

In some embodiments, dynamic navigation unit 102B may use the data sent by guidance unit 104B to update dynamic navigation model 112. Likewise, in some embodiments, proactive mitigation unit 110 may process the data sent by guidance unit 104B and/or the data in dynamic navigation model 112 to initiate or recommend proactive mitigation actions.

In some embodiments, dynamic navigation unit 102B may send guidance unit 104B data provided by proactive mitigation unit 110, such as data relating to a predicted uncertainty of positioning data in an area, and/or a recommendation or instruction to initiate a proactive mitigation action. Additionally or alternatively, dynamic navigation unit 102B may send data of dynamic navigation model 112 to guidance unit 104B. In some embodiments, dynamic navigation unit 102B may send data to guidance unit 104B via any communication means known to one of ordinary skill in the art or suitable for communicating such data.

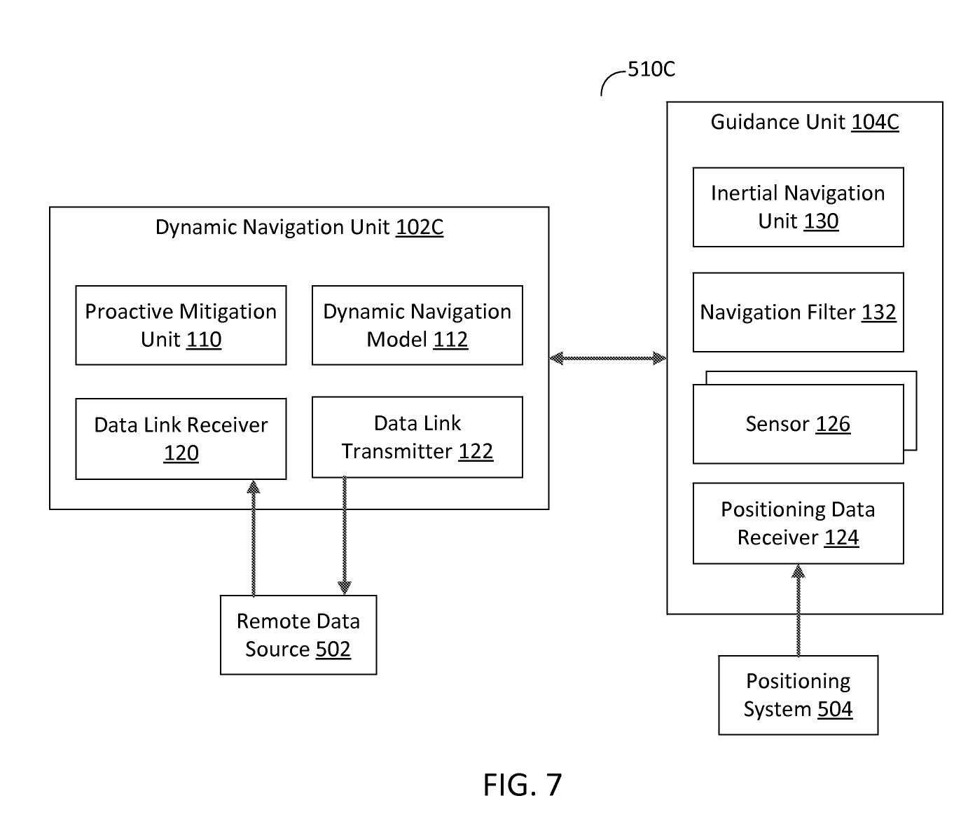

FIG. 7 is a schematic illustration of another exemplary embodiment 510C of a navigation system. The exemplary navigation system 510C comprises an embodiment 102C of a dynamic navigation unit and an embodiment 104C of a guidance unit. In exemplary navigation system 510C, the guidance unit 104C is located on, located in, or attached to a mobile entity. Dynamic navigation unit 102C may be co-located with or remote from the mobile entity.

In the embodiment of FIG. 7, dynamic navigation unit 102C of exemplary navigation system 510C comprises proactive mitigation unit 110, dynamic navigation model 112, data link receiver 120, and data link transmitter 122, while guidance unit 104C comprises positioning data receiver 124, sensor(s) 126, INS 130, and navigation filter 132. Exemplary embodiments of these components are described above and will not be discussed further here.

Locating dynamic unit 102C remotely from a mobile entity may be advantageous in some circumstances. Some advantages related to securing valuable or confidential data associated with proactive mitigation unit 110 and/or dynamic navigation model 112 are described above. In addition, data link receiver 120 and data link transmitter 122 may be bulky and heavy, or may consume a significant amount of electrical power. Thus, locating the data link receiver 120 and transmitter 122 remotely from the mobile entity may be advantageous in circumstances where decreasing the size and/or weight of the mobile entity is desirable. However, locating the data link receiver 120 and transmitter 122 remotely from the mobile entity may prevent the mobile entity from using the data link receiver 120 and transmitter 122 to determine a position of the mobile entity (e.g., by triangulation, trilateration, or multilateration).

When dynamic navigation unit 102C is located remotely from a mobile entity, guidance unit 104C may send data to dynamic navigation unit 102C, such as some or all of the data obtained via positioning data receiver 124 and/or sensor(s) 126. Additionally or alternatively, guidance unit 104C may process data obtained via positioning data receiver 124 and/or sensor(s) 126 to produce further data, and send some or all of the further data to dynamic navigation unit 102C. In some embodiments, guidance unit 104C may send data to dynamic navigation unit 102C via any communication means known to one of ordinary skill in the art or suitable for communicating such data.

In some embodiments, dynamic navigation unit 102C may use the data sent by guidance unit 104C and/or data received via data link receiver 120 to update dynamic navigation model 112. Likewise, in some embodiments, proactive mitigation unit 110 may process the data sent by guidance unit 104C, data received via data link receiver 120, and/or the data in dynamic navigation model 112 to initiate or recommend proactive mitigation actions.

In some embodiments, dynamic navigation unit 102C may send guidance unit 104C data provided by proactive mitigation unit 110, such as data relating to a predicted uncertainty of positioning data in an area, and/or a recommendation or instruction to initiate a proactive mitigation action. Additionally or alternatively, dynamic navigation unit 102C may send data of dynamic navigation model 112 to guidance unit 104C. Additionally or alternatively, dynamic navigation unit 102C may send data obtained via data link receiver 120 to guidance unit 104C. In some embodiments, dynamic navigation unit 102C may send data to guidance unit 104C via any communication means known to one of ordinary skill in the art or suitable for communicating such data.

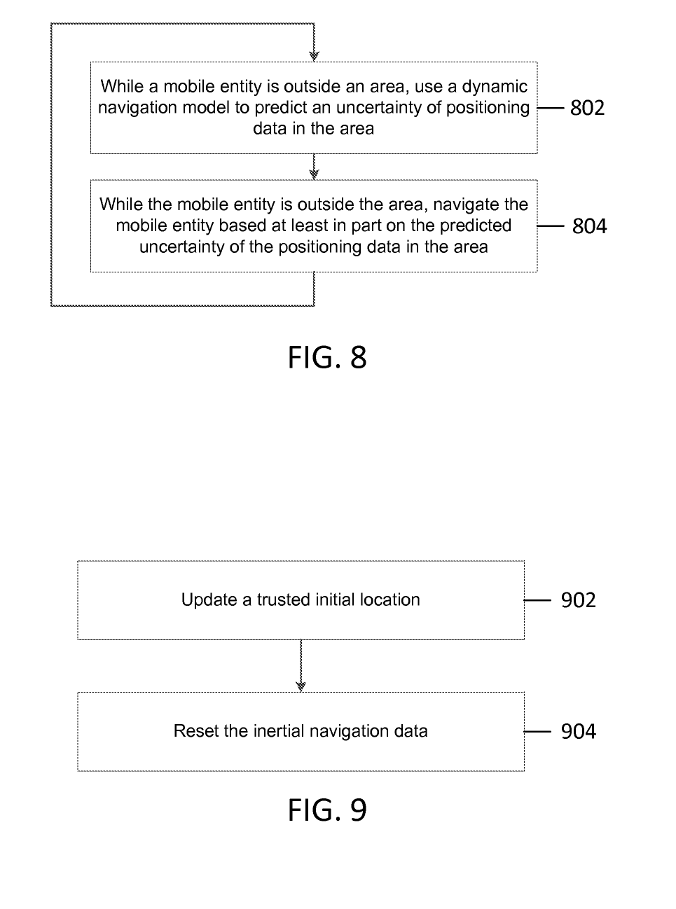

FIG. 8 depicts an exemplary method of guiding a mobile entity. In some embodiments, the mobile entity may be a vehicle, such as a car, truck, tank, boat, ship, airplane, helicopter, rocket, missile, drone, etc. In some embodiments the mobile entity may be “manned” (i.e., operated by a human). In some embodiments, the mobile entity may be “unmanned” (i.e., operated by a computer). A human or computer operator may be located remotely from a mobile entity or co-located with the mobile entity.

At act 802 of the exemplary method, a dynamic navigation model is used to predict an uncertainty of positioning data in an area. The mobile entity may be outside the area to which the predicted uncertainty applies. In some embodiments, an area may be two-dimensional or three-dimensional. In some embodiments, an area may assume an arbitrary shape, which may be set as a default or specified by a user. Predicting an uncertainty of positioning data in an area may comprise estimating a probability that an embodiment of a positioning data receiver located within the area would reliably receive accurate positioning data from a corresponding positioning system.

Act 804 of the exemplary method comprises guiding the mobile entity based at least in part on the predicted uncertainty of the positioning data in the area. The mobile entity may be outside the area to which the predicted uncertainty applies. In some embodiments, guiding may comprise controlling a rate at which the mobile entity moves (e.g., controlling acceleration or determining speed) or a direction in which the mobile entity moves (e.g., by steering), or sending signals to a controller that controls the mobile entity's movement. In some embodiments, guiding may comprise determining a route along which the mobile entity travels, a resource on which the mobile entity relies for positioning data, a destination of the mobile entity, or an objective of the mobile entity.

In some embodiments, guiding the mobile entity based at least in part on the predicted uncertainty of the positioning data comprises acting to mitigate an effect of the predicted uncertainty of the positioning data, e.g., by initiating rerouting of the mobile entity, by updating the inertial navigation system, or by issuing an alert regarding the predicted uncertainty of the positioning data to an operator of the mobile entity.

In some embodiments, rerouting may be recommended to an operator or initiated automatically if one or more rerouting criteria are satisfied. In some embodiments, updating the INS may be recommended to an operator or initiated automatically if one or more INS updating criteria are satisfied. Exemplary criteria for rerouting the mobile entity or initiating an INS update are described above.

FIG. 9 depicts an exemplary method of updating an inertial navigation system. At act 902, a trusted initial location of the INS is updated. In some embodiments, the trusted initial location is provided by another positioning system, such as GPS. At act 904, the INS is reset. Resetting the inertial navigation data may comprise recalibrating inertial sensors and/or discarding data collected by the inertial sensors prior to updating the trusted initial location.

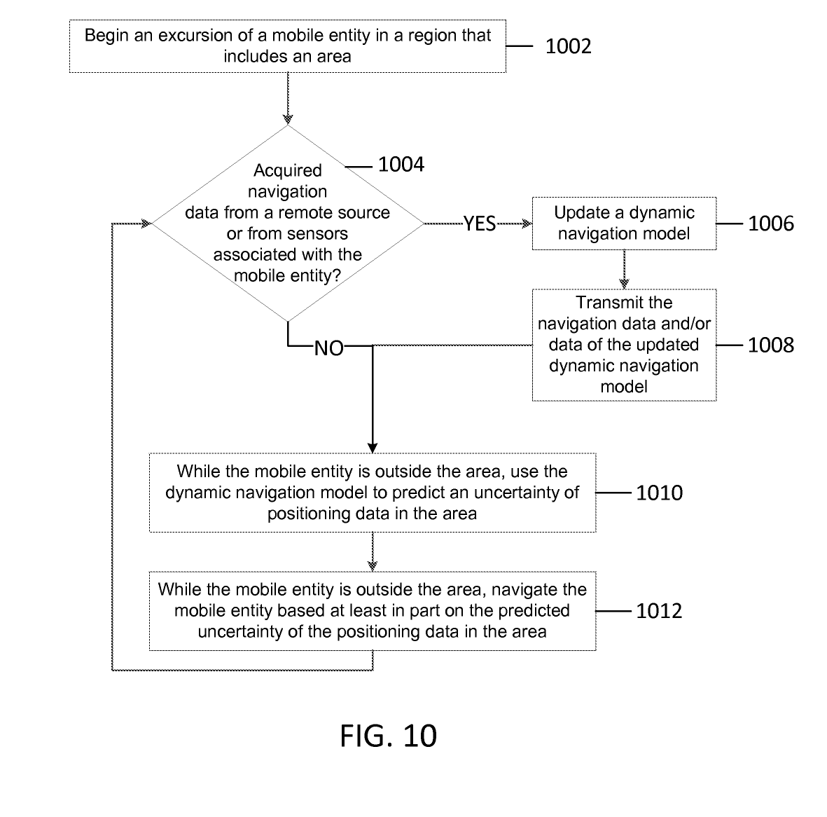

FIG. 10 depicts another exemplary method of guiding a mobile entity. At act 1002, the mobile entity begins an excursion in a region of interest that includes an area. A region of interest may be two-dimensional or three-dimensional and may comprise multiple areas. An excursion may comprise movement along a pre-determined route, movement toward a pre-determined destination, or any movement within a region of interest.

Act 1004 comprises identifying whether navigation data has been acquired from a remote data source and/or sensor(s) associated with the mobile entity. In some embodiments, navigation data may comprise positioning data, data estimating a confidence or uncertainty associated with positioning data, data suitable for integration into a dynamic navigation model (e.g., data relating to an environment model, a cost model, a positioning system model, or an excursion route model), geo-location snapshot data, or any other data that one of ordinary skill in the art might rely upon to navigate or to guide a mobile entity. In some embodiments, a remote data source may comprise a positioning system such as GPS, a second mobile entity, or a base station (e.g., a wireless communication base station).

If navigation data has been acquired, a dynamic navigation model is updated at act 1006. In some embodiments, the dynamic navigation model is updated by integrating some or all of the navigation data into the dynamic navigation model, or by modifying the dynamic navigation model based on the navigation data. In some embodiments, updating the dynamic navigation model comprises processing the navigation data and either integrating the processed data into the dynamic navigation model or modifying the dynamic navigation model based on the processed data.

In some embodiments, if navigation data have been acquired, data may be transmitted at act 1008. Some embodiments of the transmitted data may comprise the navigation data, data derived from processing the navigation data, data extracted from the dynamic navigation model, or any other data stored on or generated by a dynamic navigation unit. In some embodiments, data may be transmitted via a data link transmitter. In some embodiments, data may be transmitted via any transmission means known to one of ordinary skill in the art or suitable for transmitting data.

Acts 1010 and 1012 of the method of FIG. 10 may be similar or identical to acts 802 and 804 of FIG. 8, which are described above.

Navigating Within an Area of Uncertain Positioning Data

FIG. 11C illustrates how embodiments of a positioning data receiver 124 may be used to navigate within an area of uncertain positioning data, such as an area associated with interference. Like FIG. 11A, FIG. 11C illustrates a region of interest 1200 containing a lake 1202 and a mountain range 1204. Most areas of the region 1200 reliably receive strong signals transmitted by GPS satellites (not illustrated). However, GPS reception in the mountain range 1204 is weak and unreliable. In addition, a signal jammer interferes with GPS signals in area 1210. Accordingly, mountain range 1204 and area 1210 are both areas of uncertain positioning data.

In the illustration of FIG. 11C, a land route 1260 for an excursion from starting location 1250 to ending location 1252 has been identified. The land route 1260 avoids areas that may be unsuitable or unsafe for a land-based mobile entity 1201, such as lake 1202 and mountain range 1204. A portion of route 1260 passes through an area of uncertain positioning data 1210, in which accurate GPS positioning data is unlikely to be available, but accurate positioning data provided by a second positioning system is likely to be available. In the illustration of FIG. 11C, the mobile entity 1201 may be equipped with a positioning data receiver 124 (not illustrated) that is configured not only to receive signals from the GPS via an antenna, but also to receive positioning signals from the second positioning system via the same antenna. Thus, even though mobile entity 1201 is not subjected to the additional bulk and power dissipation of a second positioning data receiver, mobile entity 1201 may nevertheless be able to obtain accurate positioning data within area 1210 from the second positioning system.

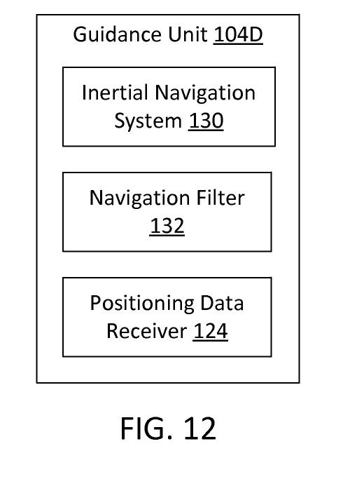

FIG. 12 is a block diagram of an exemplary embodiment 104D of a guidance unit. In the example of FIG. 12, the guidance unit 104D comprises an inertial navigation system (INS) 130, a navigation filter 132, and a positioning data receiver 124. Embodiments of inertial navigation system (INS) 130 are described above and will not be further described here.

Some embodiments of navigation filter 132 may provide a statistically optimal estimate of a mobile entity's position by monitoring data associated with positioning data receiver 124 and/or INS 130. In some embodiments, the monitored data may include positioning data provided by positioning data receiver 124 and/or positioning data provided by INS 130. In some embodiments, the monitored data may include data indicative of the accuracy of the monitored positioning data. For example, positioning data receiver 124 may provide navigation filter 132 with an estimate of the uncertainty in the positioning data provided by receiver 124. As another example, navigation filter 132 may estimate the uncertainty of the positioning data provided by INS 130 based on the time elapsed since the last INS and/or any other data known to one of ordinary skill in the art or suitable for the purpose of estimating an uncertainty of positioning data provided by an inertial navigation system.

Embodiments of navigation filter 132 may apply a filtering computation to the monitored data. In some embodiments, navigation filter 132 may compute weights associated with the positioning data based on the corresponding uncertainty data. In some embodiments, the computed weights and the positioning data may be provided to a filter, such as a Kalman filter. In some embodiments, the filtering computation may produce a statistically optimal estimate of the mobile entity's position.

In addition, in some embodiments, navigation filter 132 may initiate an INS update when update criteria are satisfied. For example, navigation filter 132 may initiate an INS update when the anticipated benefits of updating (e.g., improved accuracy of the INS) outweigh the anticipated costs of updating (e.g., diminished accuracy of the INS for the duration of the update process).

Embodiments of positioning data receiver 124 may comprise a GNSS receiver such as a GPS receiver, a GLONASS receiver, a Galileo receiver, or any other conventional GNSS receiver known to one of ordinary skill in the art or otherwise suitable for receiving signals from a GNSS. Additional embodiments of positioning data receiver 124 are described below.

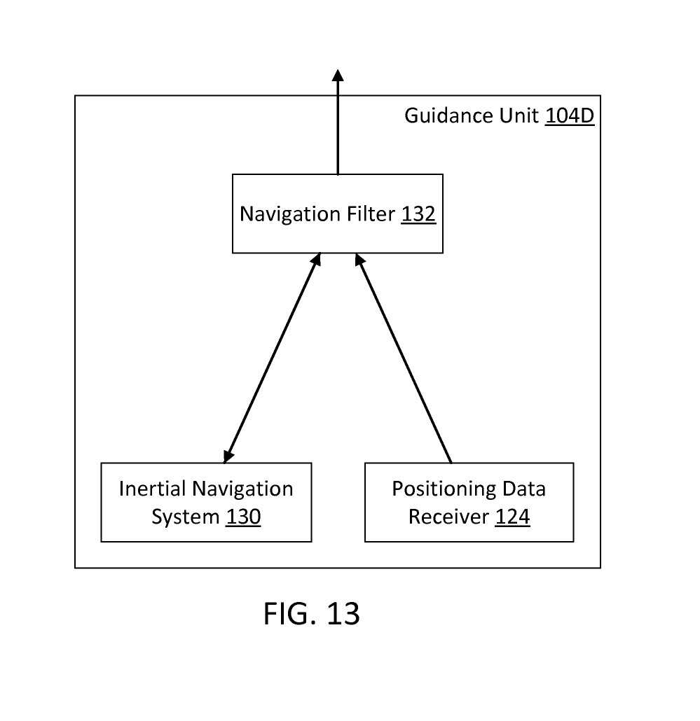

FIG. 13 is a schematic illustration of exemplary embodiment 104D of a guidance unit. In the example of FIG. 13, navigation filter is communicatively coupled to positioning data receiver 124 and to inertial navigation system 130. In addition, navigation filter 132 produces an output comprising a position of the guidance unit 104D. The output of the navigation filter 132 may optionally be an output of the guidance unit 104D, for communication to other devices.

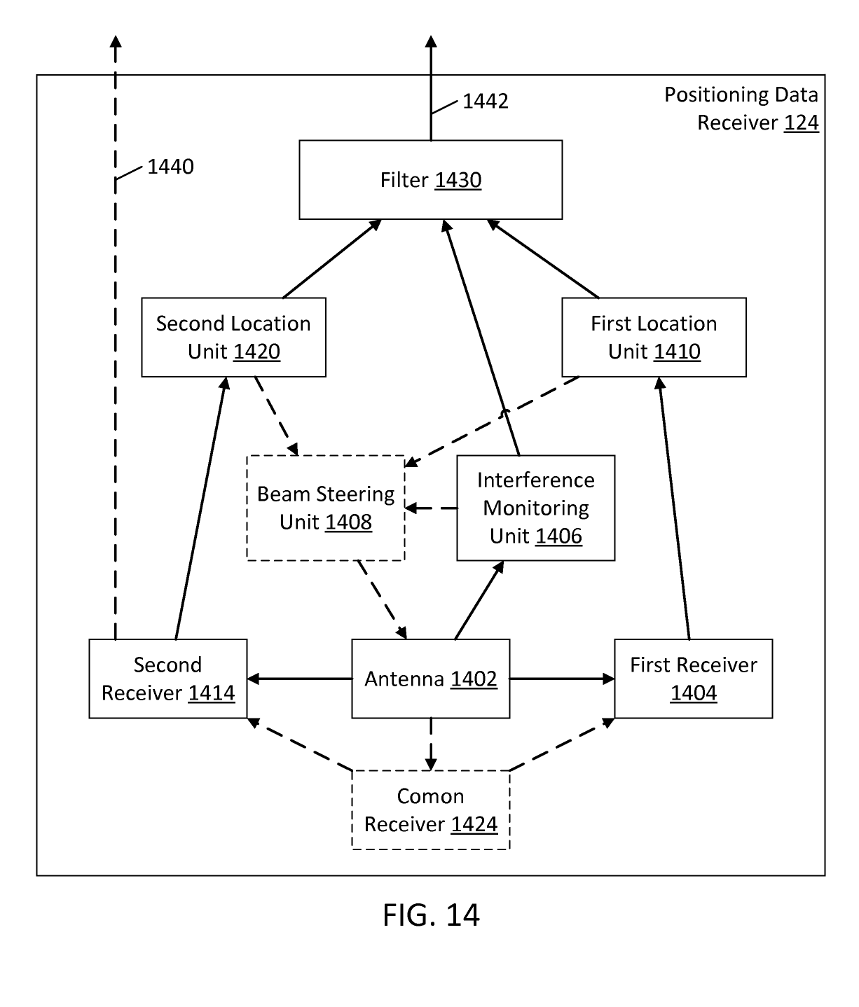

FIG. 14 is a schematic illustration of an exemplary embodiment of positioning data receiver 124. The exemplary receiver 124 comprises an antenna 1402, a first receiver 1404 and a first location unit 1410, a second receiver 1414 and a second location unit 1420, an interference monitoring unit 1406, and a filter 1430. The antenna 1402 is communicatively coupled to first receiver 1404, second receiver 1414, and interference monitoring unit 1406. First receiver 1404 is also coupled to first location unit 1410, and second receiver 1414 is also coupled to second location unit 1420. The first 1410 and second 1420 location units and interference monitoring unit 1406 are also coupled to filter 1430. Filter 1430 produces an output 1442 of positioning data receiver 124.

Antenna 1402 may comprise any means known to one of ordinary skill in the art or otherwise suitable for converting electromagnetic waves into electrical signals. In some embodiments, antenna 1402 may comprise one or more dipole antennas, parabolic antennas, patch antennas, spiral antennas, etc. In some embodiments, antenna 1402 may be configurable. Some embodiments of receiver 124 are not limited with respect to the structure, composition, arrangement, manner of operation, or any other attribute of antenna 1402. In some embodiments, antenna 1402 may be a GPS antenna. In some embodiments, a GPS antenna may be any antenna capable of receiving the signals transmitted by the GPS satellites. In some embodiments, antenna 1402 may be a GLONASS antenna, a Galileo antenna, or any other suitable means of receiving signals transmitted by a GNSS. Embodiments of antenna 1402 may be configured to receive digital or analog signals. Embodiments of antenna 1402 may be configured to receive signals from two or more positioning systems simultaneously.

First receiver 1404 may comprise a means of identifying signals of a first positioning system received by antenna 1402, and converting the signals of the first positioning system into first positioning data. In some embodiments, first receiver 1404 may be a device for identifying GPS signals received by antenna 1402 and converting the GPS signals into GPS data.

Second receiver 1414 may comprise a means of identifying signals of a second positioning system received by antenna 1402, and converting the signals of the second positioning system into second positioning data. In some embodiments, the second positioning system may be a “navigation positioning system” (NPS). An NPS may comprise any positioning system (other than the first positioning system) that transmits positioning signals suitable for reception by antenna 1402. For example, an NPS may comprise a set of transmitters broadcasting signals carrying positioning, bearing, timing, and/or ranging data. In some embodiments, the transmitters of an NPS may be associated with remote data sources, other mobile entities, and/or base stations. In some embodiments, the positioning, bearing, timing, and/or ranging data may be suitable for identifying a location of a mobile entity, e.g., by triangulation, trilateration, multilateration, etc. The transmission of signals from an NPS, reception of those signals by antenna 1402, and conversion of those signals to data by second receiver 1414 may be described as communicating over a “navigation link.”

Embodiments of an NPS may broadcast signals at one or more frequencies suitable for reception by a GPS antenna. In some embodiments, an NPS may broadcast its signals at frequencies reserved for or used by GPS signals (“GPS frequencies”). At least some of the processing (e.g., signal filtration, amplification, and/or demodulation) applied to GPS signals and NPS signals received at GPS frequencies by positioning data receiver 124 may be the same or similar. Accordingly, embodiments of positioning data receiver 124 that are configured to receive NPS signals at GPS frequencies may include a common receiver 1424 to perform at least some common processing of GPS and NPS signals. In such embodiments, first receiver 1404 and second receiver 1414 may perform processing of GPS and NPS signals, respectively, that is not performed by common receiver 1424. By using common receiver 1424 to perform at least some common processing of GPS and NPS signals, redundancies between first receiver 1404 and second receiver 1414 may be reduced, thereby reducing the bulk, weight, cost, and/or power consumption of data positioning receiver 124. As shown in FIG. 14, in embodiments of data positioning receiver 124 that include a common receiver 1424, the common receiver 1424 may be coupled to antenna 1402, first receiver 1404, and second receiver 1414. Also, the coupling between antenna 1402 and common receiver 1424 may be in addition to or in lieu of a more direct coupling between antenna 1402 and first receiver 1404, and/or a more direct coupling between antenna 1402 and second receiver 1414.

In some embodiments, an NPS may broadcast signals at frequencies not reserved for and/or used by GPS signals (“non-GPS frequencies”). Broadcasting at non-GPS frequencies may yield less interference between GPS and NPS signals, thereby reducing uncertainty in positioning data. Also, broadcasting at non-GPS frequencies may allow the NPS to avoid, in whole or in part, sources of interference that cause interference in GPS frequency bands. For example, if a signal jammer is deliberately interfering with GPS frequency bands, an NPS may avoid the harmful effects of the jammer's interference by broadcasting NPS signals at non-GPS frequencies. In some embodiments, an NPS may broadcast its signals both at GPS frequencies and non-GPS frequencies.

As used in this disclosure, “broadcast” may refer to a connectionless communication protocol. That is, “broadcasting” may refer to transmitting signals in accordance with a protocol that does not require acknowledgment of successful reception of transmitted signals.

In some embodiments, the first positioning system and second positioning system may share one or more bands of the frequency spectrum via frequency-division multiplexing (FDM), orthogonal frequency-division multiplexing (OFDM), or orthogonal frequency-division multiple access (OFDMA). Accordingly, first receiver 1404 may identify signals received at one or more frequencies or received in one or more frequency bands as signals of the first positioning system. Likewise, second receiver 1414 may identify signals received at one or more other frequencies or received in one or more other frequency bands as signals of the second positioning system. In some embodiments, the first and second positioning systems may share one or more bands of frequency spectrum via any other technique known to one or ordinary skill in the art or otherwise suitable for sharing bandwidth among two or more positioning systems. Embodiments of first 1404 and second 1414 receivers may be configured to identify signals received by antenna 1402 as corresponding to the first positioning system or the second positioning system in accordance with bandwidth-sharing technique used by the positioning systems.

In some embodiments, the power of signals received by second receiver 1414 may exceed the power of signals received by first receiver 1404. Higher-power signals may be less susceptible to interference (e.g., more difficult to jam) than are low-power signals. Thus, in some embodiments, the second signals received by second receiver 1414 may be less susceptible to interference than the first signals received by first receiver 1404. Accordingly, the data associated with the second signals may be less uncertain than the data associated with the first signals. For example, the first receiver 1404 may receive GPS signals from remote satellites, and second receiver 1414 may receive NPS signals from nearby transmitters. Because the NPS transmitters are closer than the GPS satellites to positioning data receiver 124, the power of the NPS signals may be greater than the power of the GPS signals.

Embodiments of first location unit 1410 may comprise means of identifying a first candidate position of receiver 124 by applying a location technique (e.g., triangulation, trilateration, multilateration) to the data extracted from the signals of the first positioning system by first receiver 1404. In some embodiments, first location unit 1410 may comprise a GPS location unit, hardware, software, a combination of hardware and software, or any other means known to one of ordinary skill in the art or otherwise suitable for applying a location technique to the positioning data of the first positioning system.

Embodiments of second location unit 1420 may comprise means of identifying a second candidate position of receiver 124 by applying a location technique to the data extracted from the signals of the second positioning system by second receiver 1414. In some embodiments, second location unit 1420 may comprise hardware, software, a combination of hardware and software, or any other means known to one of ordinary skill in the art or otherwise suitable for applying a location technique to the positioning data of the second positioning system.

In some cases (e.g., when there is very little interference), first and second candidate positions identified by first 1410 and second 1420 location units may be the same or nearly the same. For example, both candidate positions may be accurate. In other cases (e.g., when there is a lot of interference), first and second candidate positions identified by first 1410 and second 1420 location units may be different. For example, one candidate position may be accurate and the other may be inaccurate, or both may be inaccurate.

Embodiments of interference monitoring unit 1406 may comprise means of identifying interference with positioning system signals. In some embodiments, interference monitoring unit 1406 may comprise hardware, software, or a combination of hardware and software for analyzing signals received by antenna 1402 to detect interference. In some embodiments, interference monitoring unit 1406 may use antenna 1402 to receive signals carrying data regarding interference detected in an area or region by some other interference monitoring unit. In some embodiments, interference monitoring unit 1406 may characterize the effects of interference on the signals of the first and second positioning systems. For example, interference monitoring unit 1406 may calculate the signal-to-noise ratio (SNR) or noise margin at a frequency or within a frequency band used a positioning system. Embodiments of interference monitoring unit 1406 may provide these characterizations to filter 1430. In some embodiments, interference monitoring unit 1406 may estimate a location of a source of interference and/or characteristics of interference at a location within a region.

Embodiments of filter 1430 may provide a statistically optimal estimate of a position of positioning data receiver 124 based on first and second positioning data provided by first 1410 and second 1420 location units, respectively, and based on interference data provided by interference monitoring unit 1406. In some embodiments, filter 1430 may estimate uncertainties associated with the first and second positioning data by applying a filtering computation, such as a Kalman filter, to the first and second positioning data and the interference data. Embodiments of filter 1430 may provide an output 1442 comprising a statistically optimal estimate of a position of receiver 124 and an estimate of an uncertainty associated the estimate of the position.

In some embodiments, second receiver 1414 may also provide an output 1440 of positioning data receiver 124. Optional output 1440 may comprise data received from the second positioning system via antenna 1402, including auxiliary data (i.e., any data other than positioning, ranging, timing, and bearing data). For example, auxiliary data received from the second positioning system may comprise locations of other nearby mobile entities.

In some embodiments, receiver 124 may include a beam-steering unit 1408. Embodiments of beam-steering 1408 unit may be coupled to the first 1410 and second 1420 location units, interference monitoring unit 1406, and antenna 1402. In some embodiments, beam-steering unit 1408 may adjust a direction of a main lobe of antenna 1402 (or recommend or initiate such an adjustment). In some embodiments, beam-steering unit 1408 may receive from interference monitoring unit 1406 an estimate of a location of a source of interference and/or an estimate of interference characteristics at a location within a region. In some embodiments, beam-steering unit 1408 may analyze the data received from interference monitoring unit 1406 to determine how the direction of a main lobe of antenna 1402 might be adjusted to reduce the impact of interference. In some embodiments, beam-steering unit 1408 may analyze data provided by first 1410 and second 1420 location units to detect an impact of adjusting a direction of antenna 1402 (e.g., to detect whether adjusting the antenna's direction led to increased or decreased accuracy for each of the positioning systems).

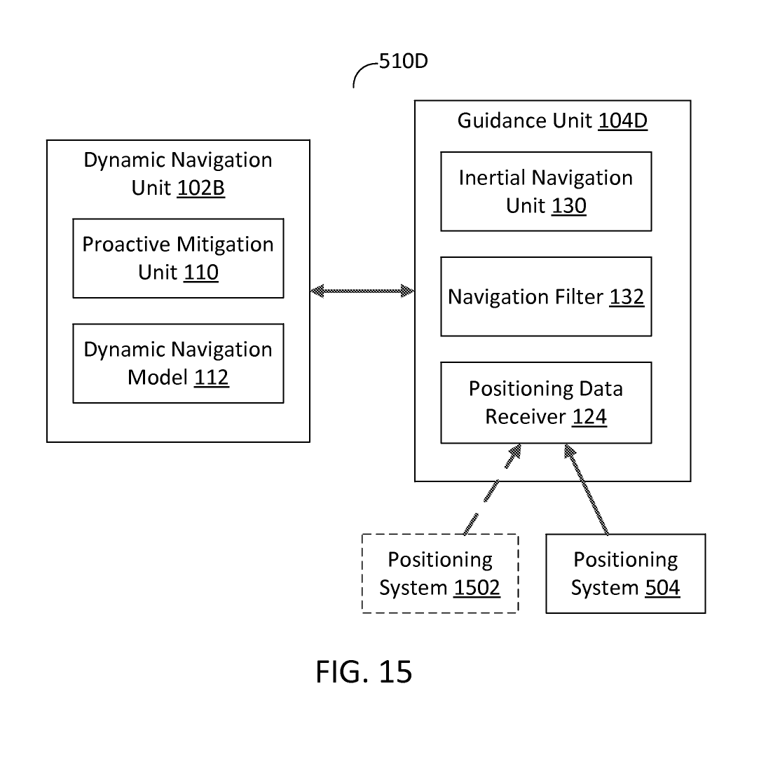

FIG. 15 is a schematic illustration of another exemplary embodiment 510D of a navigation system. The exemplary navigation system 510D comprises an embodiment 102B of a dynamic navigation unit and an embodiment 104D of a guidance unit. In exemplary navigation system 510D, the guidance unit 104D is located on, located in, or attached to a mobile entity. Dynamic navigation unit 102B may be co-located with or remote from the mobile entity.

In the embodiment of FIG. 15, dynamic navigation unit 102B of exemplary navigation system 510D comprises proactive mitigation unit 110 and dynamic navigation model 112, while guidance unit 104D comprises positioning data receiver 124, INS 130, and navigation filter 132. These components are described above and will not be discussed further here. In some embodiments, positioning data receiver 124 may comprise a receiver of a conventional positioning system, such as a GPS receiver. In some embodiments, positioning data receiver 124 may comprise an embodiment of the dual positioning data receiver 124 of FIG. 14, which may obtain positioning data from a first positioning system 504 (such as the GPS) and/or a second positioning system 1502. Thus, embodiments of navigation system 510D may combine the benefits of dynamic navigation modeling and proactive mitigation with the benefits of communicating via navigation link. In some embodiments, second positioning system 1502 may transmit positioning, timing, ranging, bearing, and/or auxiliary data.

When dynamic navigation unit 102B is located remotely from a mobile entity, guidance unit 104D may send data to dynamic navigation unit 102B, such as some or all of the data provided by positioning data receiver 124. Additionally or alternatively, guidance unit 104D may process data obtained via positioning data receiver 124 to produce further data, and send some or all of the further data to dynamic navigation unit 102B. In some embodiments, guidance unit 104D may send data to dynamic navigation unit 102B via any communication means known to one of ordinary skill in the art or otherwise suitable for communicating such data.

In some embodiments, dynamic navigation unit 102B may use the data sent by guidance unit 104D to update dynamic navigation model 112. Likewise, in some embodiments, proactive mitigation unit 110 may process the data sent by guidance unit 104D and/or the data in dynamic navigation model 112 to initiate or recommend proactive mitigation actions.

In some embodiments, dynamic navigation unit 102B may send guidance unit 104D data provided by proactive mitigation unit 110, such as data relating to a predicted uncertainty of positioning data in an area, and/or a recommendation or instruction to initiate a proactive mitigation action. Additionally or alternatively, dynamic navigation unit 102B may send data of dynamic navigation model 112 to guidance unit 104D. In some embodiments, dynamic navigation unit 102B may send data to guidance unit 104D via any communication means known to one of ordinary skill in the art or otherwise suitable for communicating such data.

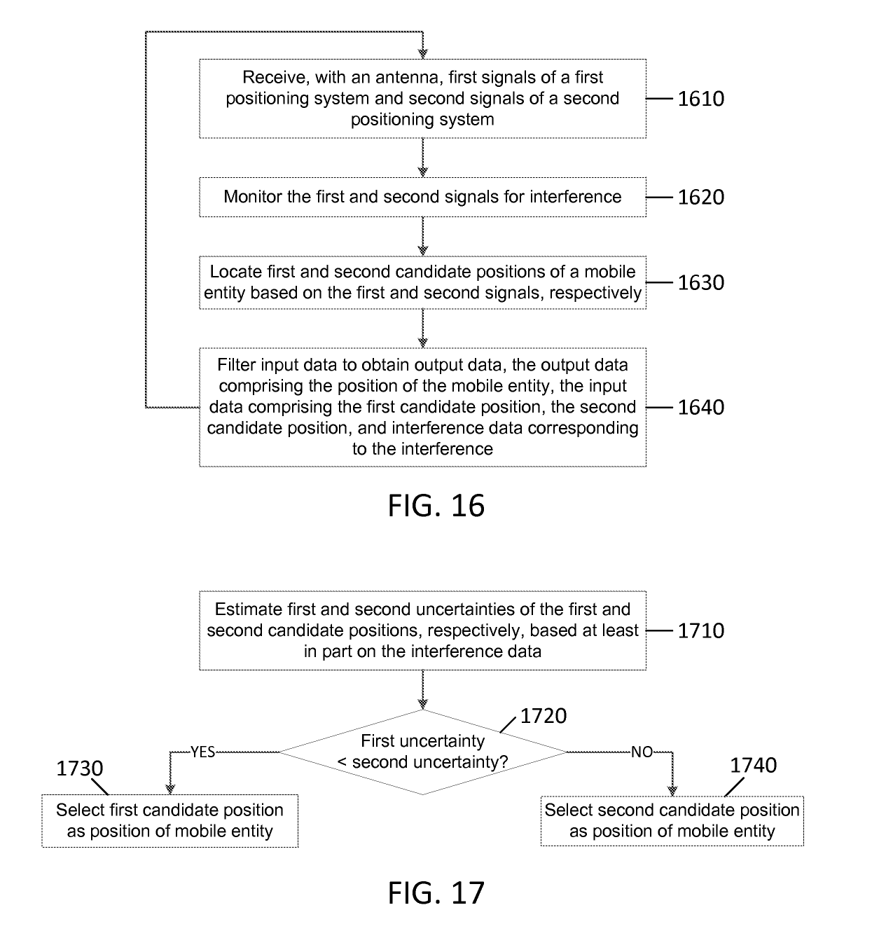

FIG. 16 depicts an exemplary method of obtaining a position of a mobile entity. At act 1610 of the exemplary method, an antenna is used to receive first signals of a first positioning system and second signals of a second positioning system. In some embodiments, the first positioning system may be the GPS. In some embodiments, the second positioning system may communicate with the mobile entity over a navigation link by broadcasting the second signals. In some embodiments, the antenna used to receive the first and second signals may be a GPS antenna.

At act 1620 of the exemplary method, the first and second signals of the first and second positioning systems, respectively, are monitored for interference. In some embodiments, the interference-monitoring is performed by an interference monitoring unit 1406. In some embodiments, monitoring the first and second signals for interference may comprise producing interference data that characterizes the effects of the interference on the first and second signals. For example, interference monitoring may comprise calculating a signal-to-noise ratio (SNR) and/or noise margin at one or more frequencies.

At act 1630 of the exemplary method, first and second candidate positions of a mobile entity are estimated based on the first and second signals, respectively. In some embodiments, estimating a candidate position of the mobile entity may comprise applying a location technique, such as triangulation, trilateration, or multilateration, to signal data (e.g., positioning, timing, bearing, and/or ranging data) extracted from the signals of a positioning system. In some embodiments, the first signals may be signals of the GPS, and the second signals may be signals broadcast over a navigation link.

At act 1640 of the exemplary method, output data is obtained by filtering input data comprising the first and second candidate positions estimated at act 1630 and the interference data produced at act 1620. The output data may comprise an estimate of the mobile entity's position. In some embodiments, the estimate may be a statistically optimal. In some embodiments, the output data may further comprise an estimated uncertainty of the mobile entity's estimated position.

The filtering process of act 1640 may be any filtering process suitable for estimating a position based on a first candidate position, a second candidate position, an interference data associated with the signals from which the first and second candidate positions were derived. For example, some embodiments of the filtering process may correspond to a Kalman filter (such as a basic Kalman filter, an extended Kalman filter, an unscented Kalman filter, a Kalman-Bucy filter, a hybrid Kalman filter, an ensemble Kalman filter, or any other variant of a Kalman filter known to one of ordinary skill in the art or suitable for navigational filtering). Some embodiments of the filtering process may correspond to an alpha-beta filter. In some embodiments, an output provided by the filtering process of act 1640 may depend not only on the current inputs (i.e., the current first and second candidate positions and the current interference data), but also on past inputs (i.e., previous first and second candidate positions and/or previous interference data) and/or past outputs (i.e., previous estimates of the position).

FIG. 17 depicts an exemplary method of filtering input data to obtain output data. At act 1710 of the exemplary method, uncertainties of the first and second candidate positions are estimated based, at least in part, on interference data associated with the first and second signals. In some embodiments, the estimated uncertainty of a candidate position may also depend on the candidate position itself, previous candidate positions, and/or previous position estimates provided by the filter.

At act 1720 of the exemplary method, the estimated uncertainties of the first and second candidate positions are compared. If the uncertainty of the second candidate position exceeds the uncertainty of the first candidate position, the first candidate position is selected as the estimated position of the mobile entity in act 1730. Otherwise (i.e., if the uncertainty of the second candidate position does not exceed the uncertainty of the first candidate position) the second candidate position is selected as the estimated position of the mobile entity in act 1740.

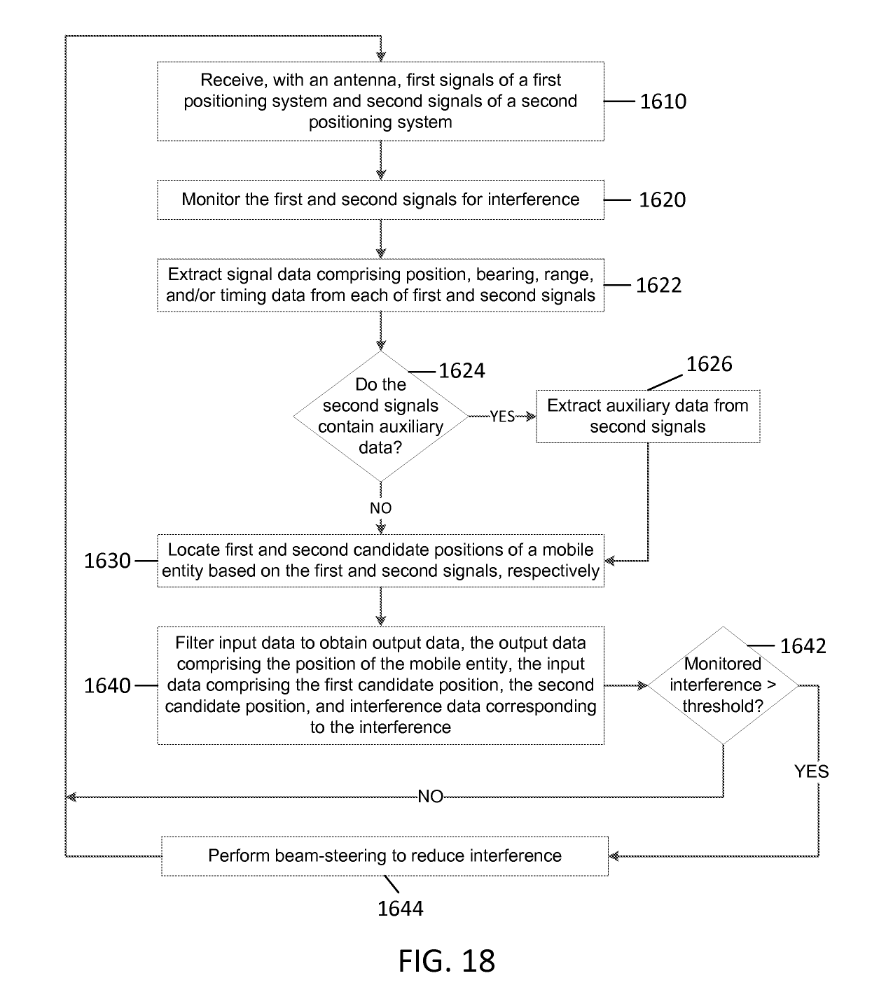

FIG. 18 depicts another exemplary method of obtaining a position of a mobile entity. Acts 1610, 1620, 1630, and 1640 of the exemplary method of FIG. 18 may be similar or identical to acts 1610, 1620, 1630, and 1640 of the exemplary method of FIG. 16, and will not be discussed further here.

At act 1622 of the exemplary method, signal data comprising positioning, bearing, ranging, and/or timing data may be extracted from each of the first and second signals. In some embodiments, the extraction operation may be performed on the first signals by a first receiver associated with the first positioning system, and the extraction operation may be performed on the second signals by a second receiver associated with a second positioning system.

At act 1624 of the exemplary method, the second signals are checked for auxiliary data. If auxiliary data is detected, the auxiliary data is extracted from the second signals at act 1626. In some embodiments, auxiliary data may be any data other than the signal data extracted at act 1622. For example, auxiliary data may comprise a location of another mobile entity. In some embodiments, the second positioning system may acquire the auxiliary data in any suitable manner, and may broadcast the auxiliary data in accordance with any suitable protocol. Embodiments of the method of FIG. 18 are not limited in this regard.

At act 1642 of the exemplary method, at least some of the interference data produced at act 1620 is compared to a threshold interference. In some embodiments, if the first and second positioning systems transmit signals at first and second frequencies, respectively, the interference data may comprise an estimate of the signal-to-noise ratios at the first and second frequencies. In such embodiments, the interference with a positioning system's signals may be regarded as exceeding an interference threshold if the SNR associated with that system's signals is lower than a corresponding SNR threshold.

At act 1644, beam-steering may be performed to reduce the interference with the signals of a positioning system. In some embodiments, beam-steering may be performed when the interference with either positioning system's signals exceeds a corresponding interference threshold. In some embodiments, beam-steering may be performed only when the interference with both positioning systems' signals exceeds the corresponding interference thresholds. The beam-steering of act 1644 may be performed by a beam-steering unit 1408.

Having thus described several embodiments of this invention, it is to be appreciated that various alterations, modifications, and improvements will readily occur to those skilled in the art. For example, in addition to the four embodiments 510A, 510B, 510C, and 510D of a navigation system described above, other embodiments of a navigation system will occur to one of ordinary skill in the art. All such embodiments are within the scope of this disclosure (e.g., embodiments involving different allocations of the navigation system components among a dynamic navigation unit 102 and a guidance unit 104, embodiments in which the navigation system includes redundant components, embodiments in which the dynamic navigation unit 102 and guidance unit 104 are integrated with each other, etc.).

As another example, embodiments are described in which a proactive mitigation unit recommends or initiates a proactive mitigation action. Recommending a proactive mitigation action may comprise displaying a message on a display screen, synthesizing the message as speech, playing an audio or audiovisual recording, etc. Initiating a proactive mitigation action may comprise controlling components to perform the proactive mitigation action.

Embodiments are described with reference to an excursion or route “through” a region of interest or an area. An excursion or route “through” a region of interest or an area may comprise an excursion or route that passes through at least a portion of the region or the area. In some embodiments, the excursion or route may begin, end, or begin and end inside the region or area. In some embodiments, the excursion or route may begin, end, or begin and end outside the region or area.

An illustration is provided in which a dynamic navigation unit responds to changes in the conditions in a region of interest. In some embodiments, actual conditions in a region of interest may remain fairly stable, while knowledge or perception of conditions in the region of interest may change. For example, data may be acquired regarding environmental features or interference conditions in the region. Such data may augment and refine an existing corpus of data regarding environmental features or interference conditions in the region. Some embodiments of dynamic navigation unit may respond to changes in knowledge or perception of conditions in a region of interest.

In addition, it is described that an embodiment of a dynamic navigation unit may include a memory. Embodiments of the dynamic navigation unit may include one or more memory units.

In addition, embodiments of the positioning data receiver 124 depicted in FIG. 14 may comprise a combination of hardware and software. For example, each of components 1404, 1406, 1408, 1410, 1414, 1420, 1424, and 1430 may be implemented as hardware (e.g., a circuit, an integrated circuit, an application-specific integrated circuit, etc.), as software executing on a processor, or as a combination of hardware and software. Software instructions may be stored in a memory (i.e. a computer-readable storage medium) and, when executed by a processor, may cause the process to perform a method associated with the corresponding component.

Such alterations, modifications, and improvements are intended to be part of this disclosure, and are intended to be within the spirit and scope of the invention. Further, though advantages of the present disclosure are indicated, it should be appreciated that not every embodiment includes every described advantage. Some embodiments may not implement any features described as advantageous herein. Accordingly, the foregoing description and drawings are by way of example only.

The above-described embodiments of the present invention can be implemented in any of numerous ways. For example, the embodiments may be implemented using hardware, software or a combination thereof. When implemented in software, the software code can be executed on any suitable processor or collection of processors, whether provided in a single computer or distributed among multiple computers. Such processors may be implemented as integrated circuits, with one or more processors in an integrated circuit component. Though, a processor may be implemented using circuitry in any suitable format.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices may be used, among other things, to present a user interface. Examples of output devices that may be used to provide a user interface include printers or display screens for visual presentation of output and speakers or other sound generating devices for audible presentation of output. Examples of input devices that may be used for a user interface include keyboards, and pointing devices, such as mice, touch pads, and digitizing tablets. As another example, a computer may receive input information through speech recognition or in other audible format.

Such computers may be interconnected by one or more networks in any suitable form, including as a local area network or a wide area network, such as an enterprise network or the Internet. Such networks may be based on any suitable technology, may operate according to any suitable protocol, and may include wireless networks, wired networks or fiber optic networks.

Also, the various methods or processes outlined herein may be coded as software that is executable on one or more processors of computers that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, embodiments of this disclosure may be embodied as a computer readable storage medium (or multiple computer readable media) (e.g., a computer memory, one or more floppy discs, compact discs (CD), optical discs, digital video disks (DVD), magnetic tapes, flash memories, circuit configurations in Field Programmable Gate Arrays or other semiconductor devices, or other tangible computer storage medium) encoded with one or more programs that, when executed on one or more computers or other processors, perform methods that implement various embodiments of this disclosure discussed above.

As is apparent from the foregoing examples, a computer readable storage medium may retain information for a sufficient time to provide computer-executable instructions in a non-transitory form. Such a computer readable storage medium or media can be transportable, such that the program or programs stored thereon can be loaded onto one or more different computers or other processors to implement various aspects of the present invention as discussed above. As used herein, the term “computer-readable storage medium” encompasses only a computer-readable medium that can be considered to be a manufacture (i.e., article of manufacture) or a machine. Alternatively or additionally, the invention may be embodied as a computer readable medium other than a computer-readable storage medium, such as a propagating signal.

The terms “program” or “software” are used herein in a generic sense to refer to any type of computer code or set of computer-executable instructions that can be employed to program a computer or other processor to implement various aspects of the present invention as discussed above. Additionally, it should be appreciated that according to one aspect of this disclosure, one or more computer programs that, when executed, perform embodiments of a disclosed method need not reside on a single computer or processor, but may be distributed in a modular fashion amongst a number of different computers or processors to implement various aspects of the present disclosure.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Also, the invention may be embodied as a method, of which examples have been provided. The acts performed as part of a method may be ordered in any suitable way. Accordingly, embodiments may be constructed in which acts are performed in an order different than illustrated, which may include performing some acts simultaneously, even though shown as sequential acts in illustrative embodiments.

The terms “location” and “position” are used interchangeably throughout this disclosure.

Use of ordinal terms such as “first,” “second,” “third,” etc., in the claims to modify a claim element does not by itself connote any priority, precedence, or order of one claim element over another or the temporal order in which acts of a method are performed. Such terms are used merely as labels to distinguish one claim element having a certain name from another element having a same name (but for use of the ordinal term).

Also, the phraseology and terminology used herein is for the purpose of description and should not be regarded as limiting. The use of “including,” “comprising,” “having,” “containing,” “involving,” and variations thereof herein, is meant to encompass the items listed thereafter and equivalents thereof as well as additional items.

What is claimed is:

1. A method for obtaining a position of a mobile entity, the method comprising:
receiving, with an antenna, first signals associated with a first positioning system and second signals associated with a second positioning system;
monitoring the first and second signals for interference;
locating a first candidate position of the mobile entity based on the first signals;
locating a second candidate position of the mobile entity based on the second signals; and
filtering input data to obtain output data, the output data comprising the position of the mobile entity, the input data comprising the first candidate position, the second candidate position, and interference data corresponding to the interference.

2. The method of claim 1, wherein the antenna is a GNSS antenna.

3. The method of claim 1, wherein the first positioning signals are broadcast by the first positioning system, and the second positioning signals are broadcast by the second positioning system.

4. The method of claim 1, further comprising using the interference data to beam-steer the antenna in a direction such that post-steering interference associated with the first signals is less than pre-steering interference associated with the first signals, and/or post-steering interference associated with the second signals is less than pre-steering interference associated with the second signals.

5. The method of claim 1, wherein the output data further comprises an estimated uncertainty of the position of the mobile entity.

6. The method of claim 1, wherein a first frequency band of the first signals and a second frequency band of the second signals differ at least in part.

7. The method of claim 1, wherein filtering the input data to obtain the output data comprises:
estimating a first uncertainty of the first candidate position based at least in part on the interference data;
estimating a second uncertainty of the second candidate position based at least in part on the interference data; and
selecting the first candidate position as the position of the mobile entity if the first uncertainty is less than the second uncertainty.

8. The method of claim 1, further comprising:
extracting first signal data from the first signals, the first signal data comprising first position data, first bearing data, first range data, and/or first timing data; and
extracting second signal data from the second signals, the second signal data comprising second position data, second bearing data, second range data, and/or second timing data.

9. The method of claim 8, further comprising extracting other data from the second signals, the other data comprising command data, control data, targeting data, and/or route data.

10. A positioning data apparatus comprising
an antenna;
a first receiver coupled to the antenna, the first receiver configured to process first signals received by the antenna, the first signals associated with a first positioning system;
a second receiver coupled to the antenna, the second receiver configured to process second signals received by the antenna, the second signals associated with a second positioning system;
an interference monitoring unit coupled to the antenna, the interference monitoring unit configured to produce interference data characterizing interference associated with the first and second signals;
a first location unit coupled to the first receiver, the first location unit configured to identify a first candidate position of the positioning data apparatus by processing first data associated with the first signals;
a second location unit coupled to the second receiver, the second location unit configured to identify a second candidate position of the positioning data apparatus by processing second data associated with the second signals; and
a filter coupled to the first location unit, the second location unit, and the interference monitoring unit, the filter configured to process input data to obtain output data, the output data comprising the position of the positioning data apparatus, the input data comprising the first candidate position, the second candidate position, and the interference data.

11. The apparatus of claim 10, wherein the antenna is a GNSS antenna.

12. The apparatus of claim 11, wherein the first positioning system is a GNSS, the second positioning system is not the GNSS, and the second positioning system provides the second signals via broadcast.

13. The apparatus of claim 11, wherein:
an electronic device comprises the apparatus;
the first positioning system is a GNSS; and
the second positioning system comprises a wireless communication base station.

14. The apparatus of claim 13, wherein the electronic device is a smart phone, a tablet computer, or a personal digital assistant (PDA).

15. The apparatus of claim 10, further comprising a beam-steering unit coupled to the first location unit, the second location unit, the interference monitoring unit, and the antenna, the beam-steering unit configured to beam-steer the antenna in a direction such that post-steering interference associated with the first signals is less than pre-steering interference associated with the first signals, and/or post-steering interference associated with the second signals is less than pre-steering interference associated with the second signals.

16. The apparatus of claim 10, wherein the output data further comprises an estimated uncertainty of the position of the positioning data apparatus.

17. A navigation system comprising:
a guidance unit including a positioning data receiver, a navigation filter, and an inertial navigation system, the navigation filter being coupled to the positioning data receiver and the inertial navigation system, the positioning data receiver including:
an antenna;
a first receiver coupled to the antenna, the first receiver configured to process first signals received by the antenna, the first signals associated with a first positioning system;
a second receiver coupled to the antenna, the second receiver configured to process second signals received by the antenna, the second signals associated with a second positioning system;
an interference monitoring unit coupled to the antenna, the interference monitoring unit configured to produce interference data characterizing interference associated with the first and second signals;
a first location unit coupled to the first receiver, the first location unit configured to identify a first candidate position of the positioning data apparatus by processing first data associated with the first signals;
a second location unit coupled to the second receiver, the second location unit configured to identify a second candidate position of the positioning data apparatus by processing second data associated with the second signals; and
a filter coupled to the first location unit, the second location unit, and the interference monitoring unit, the filter configured to process input data to obtain output data, the output data comprising the position of the positioning data receiver, the input data comprising the first candidate position, the second candidate position, and the interference data.

18. The system of claim 17, wherein the antenna is a GNSS antenna.

19. The system of claim 17, wherein the first positioning system is a GNSS, the second positioning system is not the GNSS, and the second positioning system provides the second signals via broadcast.

20. The system of claim 17, wherein the positioning data receiver further includes a beam-steering unit coupled to the first location unit, the second location unit, the interference monitoring unit, and the antenna, the beam-steering unit configured to beam-steer the antenna in a direction such that post-steering interference associated with the first signals is less than pre-steering interference associated with the first signals, and/or post-steering interference associated with the second signals is less than pre-steering interference associated with the second signals.

21. The system of claim 17, wherein the output data further comprises an estimated uncertainty of the position of the positioning data receiver.

22. The system of claim 17, further comprising a dynamic navigation unit coupled to the guidance unit.
